(19) United States
(12) Patent Application Publication
(10) Pub. No.: US 2024/0241458 A1
(43) Pub. Date: Jul. 18, 2024

(54) TONER, DEVELOPING AGENT, TONER ACCOMMODATING UNIT, IMAGE FORMING APPARATUS, AND IMAGE FORMING METHOD

(71) Applicants: Tsukiko TAKAHASHI, Shizuoka (JP); Daisuke INOUE, Shizuoka (JP); Keiji MAKABE, Shizuoka (JP); Taishi YAMASHITA, Shizuoka (JP); Shuto SUNAGA, Shizuoka (JP)

(72) Inventors: Tsukiko TAKAHASHI, Shizuoka (JP); Daisuke INOUE, Shizuoka (JP); Keiji MAKABE, Shizuoka (JP); Taishi YAMASHITA, Shizuoka (JP); Shuto SUNAGA, Shizuoka (JP)

(21) Appl. No.: 18/415,077

(22) Filed: Jan. 17, 2024

(30) Foreign Application Priority Data
Jan. 18, 2023 (JP) 2023-005894

(51) Int. Cl. G03G 9/097; G03G 9/08; G03G 9/087

(52) U.S. Cl. CPC G03G 9/09708; G03G 9/0827; G03G 9/08755; G03G 9/09733; G03G 2215/0604

(57) ABSTRACT

A toner contains a mother toner particle containing a resin, a colorant, and a wax and
an inorganic external additive on the surface of the mother toner particle, wherein the following relationships are satisfied:

$$20 < A \leq 40 \qquad Relationship 1$$

$$0 \leq B - A \leq 10 , \qquad Relationship 2$$

$$2.3 < C < 5. \qquad Relationship 3$$

where A (percent by mass) represents the liberation ratio of the inorganic external additive separated by shaking the toner with ultrasonic wave at a power of 20 W and a frequency of 20 kHz for one minute,
B (percent by mass) represents the liberation ratio of the inorganic external additive separated by shaking the toner with ultrasonic wave at a power of 60 W and a frequency of 20 kHz for one minute, and
C (percent by mass) represents the proportion of the inorganic external additive to the toner.

### CROSS-REFERENCE TO RELATED APPLICATION

This patent application is based on and claims priority pursuant to 35 U.S.C. § 119 to Japanese Patent Application No. 2023-005894, filed on Jan. 18, 2023, in the Japan Patent Office, the entire disclosure of which is hereby incorporated by reference herein.

### BACKGROUND

### Technical Field

The present disclosure relates to a toner, a developing agent, a toner accommodating unit, an image forming apparatus, and an image forming method.

### Description of the Related Art

In recent years, toners have been required to possess qualities such as reduced particle size and hot offset resistance for higher quality output images, energy efficiency through low-temperature fixing, and heat-resistant storage stability and transportation in high-temperature, high-humidity conditions after manufacturing. Particularly, as the power consumption during fixing constitutes a significant portion of the energy used in the image formation process, enhancing the low-temperature fixability is of paramount importance.

To enhance the low-temperature fixability of toner, it is necessary to use low-melting-point materials. However, toners manufactured using such materials often compromise heat-resistant storage stability, establishing a trade-off relationship between the low-temperature fixability and heat-resistant storage stability.

To address this issue, a method has been proposed to create composite resin particles by attaching resin fine particles to the surface of a resin particle, the resin fine particles containing two types of resins as constituent components within the same particle.

Subsequently, a removal process eliminates some or all of the resin from the resin fine particles, aiming to balance the low-temperature fixability and heat-resistant storage stability.

Additionally, adding resin fine particles onto the surface of toner particles has been proposed.

Concurrently, there is an increasing demand for longer working life and maintenance-free operation in photocopiers, necessitating the reduction of toner contamination within the machine. One cause of internal toner contamination is toner scattering: due to unstable electrostatic properties over time, toner fails to be adequately retained by the carrier, leading to toner scattering within the development unit and contaminating the machine. While there is a trend towards adding more additives to achieve higher suppression of toner scattering, these additives often hinder toner fixing, posing a challenge to achieve superior low-temperature fixability.

However, for the conventional technology, there is a desire for a technique that simultaneously fulfills the requirements of the low-temperature fixability and heat-resistant storage stability, suppresses contamination of cleaning components and a photoconductor, and exhibits excellent electrostatic stability to minimize toner scattering.

According to the present disclosure, a toner is provided that suppresses toner contamination within the machine while enhancing heat resistance, durability, resistance to filming, and electrostatic stability.

### SUMMARY

According to embodiments of the present disclosure, a toner is provided that contains a mother toner particle containing a resin, a colorant, and a wax and an inorganic external additive on the surface of the mother toner particle, wherein the following relationships are satisfied:

$$20 < A \leq 40 \qquad Relationship 1$$

$$0 \leq B - A \leq 10 , \qquad Relationship 2$$

$$2.3 < C < 5. \qquad Relationship 3$$

where A (percent by mass) represents the liberation ratio of the inorganic external additive separated by shaking the toner with ultrasonic wave at a power of 20 W and a frequency of 20 kHz for one minute,
B (percent by mass) represents the liberation ratio of the inorganic external additive separated by shaking the toner with ultrasonic wave at a power of 60 W and a frequency of 20 kHz for one minute, and
C (percent by mass) represents the proportion of the inorganic external additive to the toner.

As another aspect of embodiments of the present disclosure, a developing agent is provided that contains the toner mentioned above.

As another aspect of embodiments of the present disclosure, a toner accommodating unit accommodating the toner mentioned above is provided.

As another aspect of embodiments of the present disclosure, an image forming apparatus is provided that includes a latent electrostatic image bearer, a latent electrostatic image forming device for form a latent electrostatic image on the latent electrostatic image bearer, a developing device for developing the latent electrostatic image with the toner mentioned above to form a visible image, a transfer device for transferring the visible image onto a recording medium to obtain a transfer image, and a fixing device for fixing the transfer image transferred to the recording medium.

As another aspect of embodiments of the present disclosure, an image forming method is provided that includes forming a latent electrostatic image on a latent electrostatic image bearer, developing the latent electrostatic image with the toner of claim 1 to obtain a visible image, transferring the visible image to a recording medium to obtain a transfer image, and fixing the transfer image on the recording medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of the image forming apparatus according to an embodiment of the present disclosure;

FIG. 2 is a schematic diagram illustrating another example of the image forming apparatus according to another embodiment of the present disclosure.

FIG. 3 is a partial enlargement of the image forming apparatus illustrated in FIG. 2; and

FIG. 4 is a schematic diagram illustrating an example of the process cartridge related to the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a toner is provided that reduces toner contamination within the machine while enhancing heat resistance, durability, resistance to filming, and electrostatic stability.

The present invention relates to the toner with a constitution described in the following 1.
1. A toner contains a mother toner particle containing a resin, a colorant, and a wax, and an inorganic external additive on the surface of the mother particle, wherein the following relationships are satisfied.

$$20 < A \leq 40 \qquad Relationship 1$$

$$0 \leq B - A \leq 10 , \qquad Relationship 2$$

2.3<C<5.0 Relationship 3, where A (percent by mass) represents the liberation ratio of the inorganic external additive separated by shaking the toner with ultrasonic wave at a power of 20 W and a frequency of 20 kHz for one minute, B (percent by mass) represents the liberation ratio of the inorganic external additive separated by shaking the toner with ultrasonic wave at a power of 60 W and a frequency of 20 kHz for one minute, and C represents the proportion of the inorganic external additive to the toner.

Embodiments of the 1 mentioned above of the present disclosure includes the following 2 to 6. Therefore, these are also described.
2. The toner according to the 1 mentioned above, wherein the toner has an average circularity of 0.970 to 0.987.
3. The toner according to the 1 or 2 mentioned above, further contains resin fine particles on the surface of the mother toner particle, wherein the coverage ratio of the surface of the mother toner particle with the resin fine particles is from 30 to 70 percent by mass.
4. A developing agent contains a carrier and the toner of any one of the 1 to 3 mentioned above.
5. A toner accommodating unit containing the toner of any one of the 1 to 3 mentioned above.
6. An image forming apparatus includes a latent electrostatic image bearer, a latent electrostatic image forming device for forming a latent electrostatic image on the latent electrostatic image bearer, a developing device for developing the latent electrostatic image with the toner of any one of the 1 to 3 mentioned above to form a visible image, a transfer device for transferring the visible image onto a recording medium to obtain a transfer image, and a fixing device for fixing the transfer image transferred to the recording medium.
7. An image forming method includes forming a latent electrostatic image on a latent electrostatic image bearer, developing the latent electrostatic image with the toner of any one of the 1 to 3 mentioned above to obtain a visible image, transferring the visible image to a recording medium to obtain a transfer image; and fixing the transfer image on the recording medium.

### Toner

The toner of the present disclosure contains a mother toner particle containing a resin, a colorant, and a wax, and an inorganic external additive on the surface of the mother particle, wherein the following relationships are satisfied.

$$20 < A \leq 40 \qquad Relationship 1$$

$$0 \leq B - A \leq 10 , \qquad Relationship 2$$

2.3<C<5.0 Relationship 3, where A (percent by mass) represents the liberation ratio of an inorganic particle separated by shaking the toner with ultrasonic wave at a power of 20 W and a frequency of 20 kHz for one minute, B (percent by mass) represents the liberation ratio of the inorganic particle separated by shaking the toner with ultrasonic wave at a power of 60 W and a frequency of 20 kHz for one minute, and C represents the proportion of the external additive to the toner.

Deviation from the specified liberation ratios A and B, as well as the proportion C, results in carrier and component contaminations within the system over time. These contaminations lead to diminished electrostatic stability and additive filming, hindered low-temperature fixing, and reduced heat resistance storage stability.

The toner of the present disclosure preferably has an average circularity of 0.970 to 0.987.

In the present disclosure, an average toner circularity of 0.970 or higher allows additives to function effectively without being buried within the toner recesses, whereas an average circularity of 0.987 or lower prevents deterioration in cleaning properties within the system.

The toner of the present disclosure preferably has multiple resin fine particles composed of organic resin particles on the surface of the mother toner particle.

In the present disclosure, it is preferable that the mother toner particle surface coverage by the resin fine particles present on the surface of the mother toner particle be 30 to 70 percent. The toner, when within this coverage percentage range, can be hardened by the resin fine particles without substantially impeding adequate fixing. This toner thus ensures reliability in terms of the storage stability and adhesion while achieving a high level of both the low-temperature fixability and heat resistance simultaneously.

### Average Circularity

The average circularity of toner in the present disclosure can be assessed using a flow-type particle image analyzer FPIA-2100, alongside the analysis software FPIA-2100 Data Processing Program for FPIA version 00-10, available from Sysmex Corporation.

To generate a measuring sample, a process might involve placing an aqueous solution of Neogen SC-A (available from DKS Co., Ltd.) and toner into a 100 mL glass beaker; the mixture is stirred within the beaker using a microspatula, followed by the addition of deionized water; subsequently, the resulting mixture undergoes dispersion utilizing an ultrasonic disperser UH-50 (available from SMT Co., Ltd.) for 1 minute under conditions of 20 kHz and 50 W/10 cm³, with dispersion continuing for a total of 5 minutes. A segment of this measuring sample, characterized by particle concentrations ranging from 4,000 to 8,000 particles/10⁻³ cm³, is utilized for determining the average circularity of particles with an equivalent circular diameter between 0.60 μm and just under 159.21 μm.

### Coverage Ratio of Mother Toner Particle by Resin Fine Particle

The coverage ratio of the surface of mother toner particles by resin fine particles can be determined by observing the resin fine particles on the surface of mother toner particles using a scanning electron microscope (SEM), capturing images, and calculating the ratio of the resin particle's area to the mother toner particle's area using an image processing software.

Observation of resin fine particles involves the liberation of external additives through ultrasonic treatment to remove them maximally, allowing for the observation of resin fine particles in a state close to that of the mother toner particles.

The coverage ratio of resin fine particles on the surface of mother toner particles can be determined by observing the resin fine particles on the surface of mother toner particles using a scanning electron microscope (SEM), capturing images, and calculating the ratio of the resin particle's area to the mother toner particle's area using an image processing software.

Observation of resin fine particles involves the liberation of external additives through ultrasonic treatment to remove them maximally, allowing for the observation of resin fine particles in a state close to that of the mother toner particles.
(1): Pour 50 mL of a 5 percent aqueous solution containing a surfactant (Noigen ET-165, available from DKS Co., Ltd.) into a 100 mL screw tube. Then add 3 grams of toner to the solution and gently agitate it in various directions until the toner evenly disperses in the liquid. Subsequently, place the solution on a ball mill stand for 30 minutes to ensure thorough integration of the toner into the liquid dispersion.
(2): Using an ultrasonic homogenizer (model: VCX750, CV33, available from Sonics & Materials Inc.), set the output to 40 W and apply ultrasonic energy continuously for 60 minutes.

### Ultrasonic Conditions

Duration: 60 minutes continuously
Amplitude: 40 W
Temperature at initial vibration: 23±1.5 degrees C.
Temperature during vibration: 23±1.5 degrees C.
(3): Perform suction filtration on the liquid dispersion using No. 2 qualitative filter paper (110 mm, available from Advantec Toyo Kaisha, Ltd.). Follow this filtration by rinsing twice with deionized water to remove any separated inorganic external additives, and subsequently dry the obtained toner particles.
(4): Image the toner obtained in the (3) using a scanning electron microscope (SEM) under the conditions specified below. Initially, detect any remaining inorganic external additives or inorganic fillers by observing the reflected electron image.
(5): Convert the image from the (4) into binary form using an image processing software (ImageJ) to eliminate the previously detected remaining inorganic external additives and fillers.
(6): Next, observe the secondary electron image at the same positions as in the (3). Resin fine particles are only visible in the secondary electron image, not in the reflected electron image. Compare this with the image obtained in the (5) and observe the resin fine particles present, excluding the remaining inorganic additives and fillers. Use the same image processing software to measure the distances between resin fine particles. Conduct this measuring for 100 binarized images (with one toner particle per image) and calculate the average distance between resin fine particles.

### Imaging Condition

Scanning Electron Microscope: SU-8230 (available from Hitachi High-Technologies Corporation)
Magnification: 35,000×
Imaging Modes: SE (L) (Secondary Electrons), Backscattered Electrons (BSE)
Accelerating Voltage: 2.0 kV
Beam Current: 1.0 μA
Probe Current: Normal
Focus Mode: UHR
Working Distance (WD): 8.0 mm
(7): From the (6), generate an image displaying only resin fine particles on the mother toner particle after removing inorganic external additives and fillers. Calculate the area occupied by the resin fine particles using an image processing software in relation to the mother toner particle. Capture an image at 35,000× magnification to ensure the entire image is filled with the mother toner particle, then calculate the area occupied by the resin fine particles within this image. Subsequently, consider the image area as the area of mother toner particles and calculate the proportion of the area occupied by the resin fine particles within the image area as the coverage ratio of the resin fine particles. Repeat this process with images of ten different mother toner particles and use the average values as the coverage ratio of the resin fine particles.

### Liberation Ratio and Coverage Ratio of Inorganic External Additive

The liberation ratios A and B, as well as the content ratio C of the inorganic additive in this toner, can be determined through the following steps:

The content ratio C of the inorganic external additive is assessed using a fluorescent X-ray device (ZSX-100e, available from Rigaku Corporation) for quantitative analysis to quantify the number of parts of inorganic external additives present in the sample toner formed into pellets. A calibration curve is established beforehand using a sample toner with the inorganic external additive content set to a specific value for 100 parts of the toner.

Furthermore, the liberation ratios A and B (percent by mass) of the inorganic particles (inorganic external additive) within the toner are calculated as per the following formula:

Liberation ratio of inorganic particles (percent by mass)=([Content (number of parts) of inorganic external additives in the sample toner prior to processing]−[Final content (number of parts) of inorganic external additives in the processed sample toner])/[Number of sample toner prior to processing]×100

The liberation ratio A of the inorganic particles represents the ratio at an ultrasonic condition amplitude of 20 W during the liberation method of the inorganic external additive, while the liberation ratio B indicates the ratio at an ultrasonic condition amplitude of 60 W during the liberation method of the inorganic external additive.

In the following, the components constituting the toner of the present disclosure, a carrier, a method of manufacturing the toner, a developing agent, a toner accommodating unit, an image forming apparatus, and an image forming method are described.

### Mother Toner Particle

The mother toner particle outlined in the present disclosure consist of resin, a colorant, and wax at a minimum, with the potential inclusion of other optional components.

Preferably, the mother toner particle is produced by dissolving or dispersing a resin, a colorant, and a wax in an organic solvent. The resulting solution or dispersion is then introduced into an aqueous phase, after which the organic solvent is removed from the resulting dispersion. Furthermore, it is favorable to dissolve or disperse a resin precursor and a colorant in an organic solvent. This solution or dispersion is then added to an aqueous phase to cross-link or elongate the resin precursor, followed by the removal of the organic solvent.

As for the toner itself, it commonly contains polyester as the resin, ideally incorporating a non-linear amorphous polyester resin, and preferably an incorporating crystalline polyester resin.

The components insoluble in THF preferably contain a non-linear amorphous polyester resin or crystalline polyester resin.

### Amorphous Polyester Resin

The amorphous polyester resin contained in the toner of the present disclosure is obtained using a polyhydric alcohol component and a polybasic carboxylic acid component such as a polybasic carboxylic acid, polybasic carboxylic acid anhydride, and polybasic carboxylic acid ester.

The amorphous polyester resin in this disclosure is derived from a combination of a polyhydric alcohol component and various polybasic carboxylic acid components, including polybasic carboxylic acid, its anhydride, and ester forms, as described above.

The term ‘amorphous polyester resin’ as referred to herein, specifically excludes modified polyester resins such as prepolymers mentioned later or any resins formed by cross-linking and/or elongating these prepolymers.

### Polyhydric Alcohol Component

Specific examples of polyhydric alcohol components include various compounds, such as adducts of bisphenol A with alkylene oxides containing two or three carbon atoms and an average adduction molar number of from 1 to 10. Examples of these compounds are polyoxypropylene(2,2)-2,2-bis(4-hydroxyphenyl)propane and polyoxyethylene(2,2)-2,2-bis(4-hydroxyphenyl)propane. Additionally, this category encompasses ethylene glycol, propylene glycol, neopentyl glycol, glycerol, pentaerythritol, trimethylolpropane, hydrogenated bisphenol A, sorbitol, and their derivatives involving alkylene oxides containing two or three carbon atoms and an average adduction molar number ranging from 1 to 10. These can be used alone or in combination.

### Polycarboxylic Acid Component

As for the polybasic carboxylic acid components, specific examples include, but are not limited to, dicarboxylic acids such as adipic acid, phthalic acid, isophthalic acid, terephthalic acid, fumaric acid, and maleic acid; succinic acids substituted with alkyl groups of carbon number of 1 to 20 or alkenyl groups of carbon number of 2 to 20 such as dodecenyl succinic acid and octyl succinic acid; trimellitic acid and pyromellitic acid; and anhydrides of these acids and alkyl (carbon number of 1 to 8) esters of these acids. These can be used alone or in combination.

Preferably, the amorphous polyester resin and the resin obtained by cross-linking and/or elongating the prepolymers described later are at least partially compatible. The compatibility of these components enhances the low-temperature fixability and high-temperature offset resistance. Therefore, it is desirable for the polyhydric alcohol components and polybasic carboxylic acid components constituting the amorphous polyester resin and those constituting the prepolymers described later to have similar compositions.

The molecular weight of the amorphous polyester resin is not particularly limited and can be suitably selected to suit to a particular application.

However, an excessively low molecular weight may compromise the thermal stability of the toner and its durability against stresses such as agitation within the developing unit.

Conversely, unless the molecular weight is excessively high, it does not hinder an increase in the resin's viscosity during toner melting, thus maintaining good low-temperature fixing properties.

Therefore, in gel permeation chromatography (GPC) measurements, it is preferable for the weight-average molecular weight Mw of the amorphous polyester resin to range from 2,500 to 10,000, the number-average molecular weight Mn to range from 1,000 to 4,000, and the Mw/Mn ratio to be from 1.0 to 4.0.

The acid value of the amorphous polyester resin has no particular limit and can be suitably selected to suit to a particular application. However, a range of 1 to 50 mg KOH/g is preferable, with 5 to 30 mg KOH/g being even more favorable. Having an acid value of at least 1 mg KOH/g makes toner more prone to negative charging, and furthermore, it enhances the affinity between the toner and paper during fixing, thereby improving the low-temperature fixability. Ensuring the acid value does not surpass 50 mg KOH/g prevents a decrease in the charge stability, particularly in terms of the electrostatic stability under environmental fluctuations.

The hydroxyl value of the amorphous polyester resin is not particularly limited and can be suitably selected to suit to a particular application. The value is preferably 5 or more mgKOH/g.

The glass transition temperature Tg of the amorphous polyester resin is not particularly limited and can be suitably selected to suit to a particular application.

However, an extremely low Tg may compromise the toner's heat resistance and its durability against stresses such as agitation within the developing unit. Conversely, an extremely high Tg may hinder an increase of the resin's melt viscosity during toner melting, resulting in inferior low-temperature fixability. Therefore, a range of 40 to 70 degrees C. is preferable, with 45 to 60 degrees C. being even more favorable.

The content of the amorphous polyester resin B is not particularly limited and can be suitably selected to suit to a particular application. The number of parts of the amorphous polyester resin to 100 parts by mass of the toner mentioned above is preferably from 50 to 95 parts by mass and more preferably from 60 to 90 parts by mass. When the content is 50 or more parts by mass, the dispersion of pigments and release agents in the toner is excellent, reducing the likelihood of fogging and disturbance. If it is 95 or less parts by mass, it ensures that the content of crystalline polyester is not excessively reduced, resulting in good low-temperature fixability.

Within the more preferable range, it is advantageous to excel in image quality and stability, along with low-temperature fixability.

The molecular structure of the amorphous polyester resin can be analyzed by measuring a solution or solid using methods such as NMR, X ray diffraction, GC/MS, LC/MS, and infrared (IR) absorption. A method of detecting an amorphous polyester resin involves simply identifying substances in the infrared absorption spectrum that do not exhibit absorption based on the δCH (out-of-plane bending vibration) of olefins at 965±10 cm⁻¹ and 990±10 cm⁻¹.

### Crystalline Polyester Resin

The crystalline polyester resin contained in the toner of the present disclosure has a structure unit derived from a saturated aliphatic diol.

As this saturated aliphatic diol, using an alcohol component containing a straight chain aliphatic diol with 2 to 8 carbon atoms is preferable.

With such a diol, the crystalline polyester resin can be uniformly micro-dispersed within the toner, preventing the filming of the crystalline polyester resin, enhancing the stress resistance, and achieving the low-temperature fixability of the toner.

The crystalline polyester resin has a high crystallinity, thereby exhibiting a heat-melt property demonstrating a sharp drop in viscosity around the fixing starting temperature. Using such a crystalline polyester resin in the toner results in formation of toner with excellent heat resistance due to crystallinity up to the immediate melting initiation temperature. At the melting initiation temperature, there is a sharp decrease in viscosity (sharp melting property), allowing for fixing. This yields toner possessing both excellent heat resistance and low-temperature fixability. Additionally, it demonstrates favorable results regarding the release width (the difference between the minimum fixing temperature and the temperature at which hot offset occurs).

The crystalline polyester resin is derived from a combination of a polyhydric aldol component and various polybasic carboxylic acid components, including polycarboxylic acids and their anhydrides and ester forms.

The crystalline polyester resin in this disclosure is derived from a combination of a polyhydric alcohol component and various polycarboxylic acid components, including polycarboxylic acid, its anhydride, and ester forms, as described above.

The term “crystalline polyester resin”, as referred to herein, specifically excludes modified polyester resins such as prepolymers mentioned later or any resins formed by cross-linking and/or elongating these prepolymers.

### Polyhydric Alcohol Component

The polyhydric alcohol component is not particularly limited and can be suitably selected to suit to a particular application. Examples include, but are not limited to, diol and tri- or higher alcohols.

One of them is a saturated aliphatic diol. The saturated aliphatic diols encompass straight-chain and branched-chain types, with preference given to the straight-chain variants. Particularly advantageous are the straight-chain saturated aliphatic diols with carbon numbers ranging from 2 to 8. A branched-type saturated aliphatic diol may diminish the crystallinity of the crystalline polyester resin, thereby lowering its melting point. Additionally, an aliphatic diol containing fewer than 2 carbon atoms in the main chain exhibits a higher melting temperature when polycondensed with an aromatic dicarboxylic acid, negatively impacting lower temperature fixing. Moreover, an aliphatic diol with more than 8 carbon atoms in the main chain might be less readily available. It is more preferable for the number average molecular weight to be 8 or less.

Specific examples of the saturated aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol. Of these, ethylene glycol, 1,3-propanediol, 1,4-butanediol, 1,5-pentanediol, and 1,6-hexanediol are preferable due to their high crystallinity and excellent sharp melting characteristics in the crystalline polyester resin.

Specific examples of the tri- or higher alcohol having include, but are not limited to, glycerin, trimethylol ethane, trimethylol propane, and pentaerythritol.

These can be used alone or in combination.

### Polycarboxylic Acid Component

The polycarboxylic acid component includes the use of sebacic acid; however, depending on the purpose, other dicarboxylic or polycarboxylic acids can be used in combination.

Specific examples of dicarboxylic acids include, but are not limited to, saturated aliphatic dicarboxylic acid such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid, aromatic dicarboxylic acids such as phthalic acid, isophthalic acid, terephthalic acid, naphthalene-2,6-dicarboxylic acid, malonic acid, mesaconic acid; and their anhydride and lower alkyl esters.

Specific examples of the tri- or higher carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters.

The polycarboxylic acid component includes dicarboxylic acid components having a sulfonate group, along with the above-specified saturated aliphatic dicarboxylic acids and aromatic dicarboxylic acids. It may furthermore include a dicarboxylic acid component having carbon-carbon double bond other than the above-specified saturated aliphatic dicarboxylic acids and aromatic dicarboxylic acids.

These can be used alone or in combination.

The melting point of the crystalline polyester resin is not particularly limited and can be suitably selected to suit to a particular application. It is preferably from 60 to below 80 degrees C. A crystalline polyester resin with a melting point below 60 degrees C. is prone to melting at low temperatures, compromising the heat resistance of toners. Conversely, a crystalline polyester resin with a melting point 80 or higher degrees C. may undergo insufficient melting during the fixing process, potentially resulting in reduced low-temperature fixability.

The melting point is determined based on the endothermic peak value in the differential scanning calorimetry (DSC) curve in DSC measuring.

The molecular weight of the crystalline polyester resin is not particularly limited and can be suitably selected to suit to a particular application. However, it is to be noted that while lower molecular weight components with a sharp distribution can improve the low-temperature fixability, an excess of these components may compromise the heat resistance. Therefore, the soluble fraction of the crystalline polyester resin in ortho-dichlorobenzene, as measured by GPC, is preferably within a range of weight-average molecular weight Mw of 3,000 to 30,000, number-average molecular weight Mn of 1,000 to 10,000, and Mw/Mn ratio of 1.0 to 10.

The acid value of the crystalline polyester resin is not particularly limited and can be suitably selected to suit to a particular application; it is, however, preferably 5 or more mgKOH/g, and more preferably 10 or more mgKOH/g to achieve target low temperature fixability in terms of affinity between paper and resin. Conversely, to enhance the hot offset resistance, the acid value is preferably 45 or lower mgKOH/g.

The hydroxyl value of the crystalline polyester resin is not particularly limited and can be suitably selected to suit to a particular application; it is, however, preferably 0 to 50 mgKOH/g and more preferably 5 to 50 mgKOH/g to achieve target low temperature fixability and good chargeability.

The molecular structure of the crystalline polyester resin can be analyzed by measuring a solution or solid using methods such as NMR, X ray diffraction, GC/MS, LC/MS, and infrared (IR) absorption. A method of detecting a crystalline polyester resin involves simply identifying substances in the infrared absorption spectrum that exhibits absorption based on the δCH (out-of-plane bending vibration) of olefins at 965±10 cm⁻¹ and 990±10 cm⁻¹.

The content of the crystalline polyester resin B is not particularly limited and can be suitably selected to suit to a particular application. The number of parts of the amorphous polyester resin to 100 parts by mass of the toner mentioned above is preferably from 2 to 20 parts by mass and more preferably from 5 to 15 parts by mass. Having a crystalline polyester resin content of 2 or more parts by mass contributes to the toner's sharp melting, thereby enhancing the low-temperature fixability. A content of the crystalline polyester resin at 20 or lower parts by mass is less likely to compromise heat-resistant storage stability or cause image fogging.

Within the more preferable range, it is advantageous to excel in the image quality and stability, along with the low-temperature fixability.

### Inorganic Filler

The mother toner particle in the toner of the present disclosure can be manufactured with an inorganic filler. This inorganic filler is not particularly limited. Substances such as calcium carbonate, kaolin clay, talc, and barium sulfate can be used singly or in combination as an inorganic filler. A filler surface-treated with a substance such as a silane coupling agent, surfactant, and metal soap or adjusted by classification or other methods to achieve a target particle diameter distribution can also be used as this inorganic filler.

The inorganic filler contained in the toner of the present disclosure is preferably a layered inorganic mineral, along with the above-mentioned. Of the layered inorganic minerals, a layered inorganic mineral modified with an organic ion is preferable. The term “layered inorganic mineral” represents an inorganic mineral formed of stacked layers each with a thickness of several nanometers. “Modified with an organic ion” signifies introducing an organic ion into an ion present between the layers.

As layered inorganic minerals, smectite minerals (such as montmorillonite and saponite), kaolin minerals (e.g., kaolinite), magadiite, and kanemite are known. Modified layered inorganic minerals exhibit high hydrophilicity due to their modified layered structure. Consequently, non-modified layered inorganic minerals dispersed in an aqueous medium for toner granulation migrate within the aqueous medium, failing to produce irregular toner particles.

However, through modification, the enhanced hydrophilicity enables these modified layered inorganic minerals to become reduced in size, forming irregular fine particles during manufacturing. They are particularly abundant on the surface of the toner particles, facilitating uniform dispersion on the entire mother toner particles. Moreover, they serve to charge control and low temperature fixing. In this scenario, the content of the modified layered inorganic minerals in toner materials is preferably 0.2 to 1.5 percent by mass.

The modified layered inorganic mineral used in the present disclosure is preferably obtained by modifying an inorganic mineral having a smectite-based crystal structure with an organic cation. Additionally, introducing metal anions by partially substituting trivalent metals for some of the divalent metals in the layered inorganic mineral is possible. However, since the introduction of metal anions increases hydrophilicity, it is desirable for at least some of the metal anions to be modified with organic anions in the layered inorganic compound.

The organic ion modification agent for layered inorganic minerals, wherein at least a portion of the ions possessed by the aforementioned layered inorganic minerals is altered by organic ions, includes, but is not limited to, quaternary alkylammonium salts, phosphonium salts, imidazolium salts with a preference for quaternary alkylammonium salts.

Specific examples of the quaternary ammonium ion include, but are not limited to, trimethyl stearyl ammonium, dimethyl stearyl benzyl ammonium, dimethyl octadecyl ammonium, and oleylbis(2-hydroxyethyl) methyl ammonium.

As additional organic ion modifiers, sulfuric acid salts, sulfonic acid salts, carboxylic acid salts, or phosphoric acid salts containing branched, unbranched, or cyclic alkyl (C1-C44), alkenyl (C1-C22), alkoxy (C8-C32), hydroxyalkyl (C2-C22), ethylene oxide, propylene oxide, and similar compounds are listed. Carboxylic acids possessing an ethylene oxide backbone are preferable.

By modifying at least a portion of layered inorganic minerals with organic ions, it becomes possible to possess moderate hydrophobicity, and the oil phase containing toner compositions and/or toner composition precursors exhibits non-Newtonian viscosity, producing irregular shaped toner particles. The preferred content of the layered inorganic minerals partially modified with organic ions in toner materials ranges from 0.2 to 1.5 mass percent.

The layered inorganic minerals partially modified with organic ion can be selectively chosen, with options including montmorillonite, bentonite, hectorite, attapulgite, sepiolite, and mixtures thereof. Of these, montmorillonite or bentonite containing aluminum element, which enhances the charge capacity, are preferable.

Specific examples of the procurable layered inorganic minerals partially modified with organic cation include, but are not limited to, QUANTERNIUM 18 bentonite such as BENTONE 3, BENTONE 38 (both available from RHEOX INTERNATIONAL INCORPORATED), THIXOGEL VP (available from UNITED CATALYST), CLAYTONE 34, CLAYTONE 40, and CLAYTONE XL (available from SOUTHERN CLAY PRODUCTS, INC.); stearalconium bentonite such as BENTONE 27 (available from RHEOX INTERNATIONAL INCORPORATED), THIXOGEL1 LG (available from United Catalyst), CLAYTONE AF and CLAYTONE APA (available from SOUTHERN CLAY PRODUCTS, INC.); QUANTERNIUM 18/benzalkonium bentonite such as CLAYTONE HT and CLAYTONE PS (available from SOUTHERN CLAY PRODUCTS, INC.). Clayton AF and Clayton APA are particularly preferable. Additionally, among the layered inorganic minerals partially modified by organic anions, those of DHT-4A (available from Kyowa Chemical Industry Co., Ltd.) modified with the organic anion represented by the following Chemical Formula 3 are especially preferable. One of the compounds represented by Chemical Formula 3 is HITENOL 330T (available from DKS Co., Ltd.).

R1(OR2)nOSO3M Chemical Formula 3

In Chemical Formula 3, R1 represents an alkyl group with 13 carbon atoms, R2 represents an alkylene group with 2 to 6 carbon atoms. ‘n’ represents an integer from 2 to 10,
and ‘M’ represents a monovalent metal element.

### External Additive

The toner of the present disclosure contains an external additive including an inorganic external additive and other external additives,

### External Additive

As the inorganic external additive, inorganic fine particles and hydrophobized inorganic fine particles can be used in combination other than oxide fine particles. The hydrophobized primary particle has an average particle diameter (size) of from 1 to 200 nm and more preferably from 10 nm to 150 nm. Furthermore, it is more preferable to contain at least one type of hydrophobized inorganic fine particles having an average primary particle diameter of 30 or less nm and at least one type of hydrophobized inorganic fine particles having an average primary particle diameter of 50 or more nm. Inorganic fine particles with an average particle diameter of 50 or more nm are likely to be trapped by a blade, enhancing filming properties and cleaning performance.

In addition, it is preferable that the specific surface as measured by BET method be 20 to 500 m²/g.

There is no specific limitation to the inorganic external additives and it can be suitably used.

Specific examples include, but are not limited to, silica fine particles, hydrophobic silica, aliphatic acid metal salts (such as zinc stearate and aluminum stearate), metal oxides (such as titania, alumina, tin oxide, and antimony oxide), and fluoropolymers.

The proportion of the inorganic external additive is not particularly limited and can be suitably selected to suit to a particular application. Its number of parts by mass is preferably from 0.5 to 6.0 parts by mass and more preferably from 1.0 to 4.0 parts by mass to 100 parts by mass of mother toner particles.

### Other External Additive

The other external additives include titania, titanium oxide, and alumina fine particles. Specific examples of the titania fine particles include, but are not limited to, P-25 (available from NIPPON AEROSIL CO., LTD.), STT-30 and STT-65C-S (both available from TITAN KOGYO, LTD.), TAF-140 (available from FUJI TITANIUM INDUSTRY CO., LTD.), and MT-150 W, MT-500B, MT-600B, and MT-150A (all available from TAYCA CORPORATION).

Specific examples of the hydrophobized titan oxide fine particles include, but are not limited to, T-805 (available from NIPPON AEROSIL CO., LTD.); STT-30A and STT-65S-S (both available from TITAN KOGYO, LTD.); TAF-500T and TAF-1500T (both available from FUJI TITANIUM INDUSTRY CO., LTD.); MT-100S and MT-100T (both available from TAYCA CORPORATION); and IT-S(available from ISHIHARA SANGYO KAISHA LTD.).

The hydrophobized oxide fine particles, the hydrophobized silica fine particles, the hydrophobized titania particulates, and the hydrophobized alumina fine particles can be obtained by treating hydrophillic fine particles with a silane coupling agent such as methyl trimethoxyxilane, methyltriethoxy silane, and octyl trimethoxysilane. Silicon oil treated oxide fine particles and inorganic fine particles, which are optionally treated with heated silicone oil, are also preferable.

Specific examples of the silicone oils include, but are not limited to, dimethyl silicone oil, methylphenyl silicone oil, chlorophenyl silicone oil, methylhydrogene silicone oil, alkyl-modified silicone oil, fluorine-modified silicone oil, polyether-modified silicone oil, alcohol-modified silicone oil, amino-modified silicone oil, epoxy-modified silicone oil, epoxy/polyether silicone oil, phenol-modified silicone oil, carboxyl-modified silicone oil, mercapto-modified silicone oil, (meth)acryl-modified silicone oil, and α-methylstyrene-modified silicone oil.

Specific examples of such inorganic fine particles include, but are not limited to, silica, alumina, titanium oxide, barium titanate, magnesium titanate, calcium titanate, strontium titanate, iron oxide, copper oxide, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Of these, silica and titanium dioxide are particularly preferred.

The proportion of the other external additive is not particularly limited and can be suitably selected to suit to a particular application. It is preferably from 0.1 to 5 percent by mass and more preferably from 0.3 to 3 percent by mass to the toner.

The average particle diameter of the primary particle of the inorganic fine particles is not particularly limited and can be suitably selected to suit to a particular application. For example, it is preferably 200 or less nm and more preferably from 10 to 100 nm. Below this range, the inorganic fine particles tend to bury within the toner, limiting their effective functionality. Moreover, beyond this range, it is undesirable as larger particles may unevenly damage the surface of the photosensitive drum.

### Resin Fine Particle

The toner of the present disclosure preferably holds multiple resin fine particles on the surface of the mother toner particle.

In the present disclosure, the resin fine particles covering the surface of a mother toner particles may have a core-shell structure formed of the shell portion and the core portion.

The toner of the present disclosure preferably contains resin fine particles. In the present disclosure, it is preferable that the resin fine particles be present, covering the surface of a mother toner particles, and have a core-shell structure formed of the shell portion and the core portion.

The resin fine particles are present to cover the surface of the mother toner particles with multiple resin fine particles. The coverage ratio of the resin fine particles on the surface of the mother toner particle is preferably 30 to 70 percent.

A coverage ratio of 30 or more percent ensures the heat-resistant storage stability of the toner and inhibits the embedding of zinc stearate. A coverage ratio of 70 or less percent facilitates attachment of external additives and enhances thermal transfer during toner fixing, ensuring good fixability.

### Measuring Distance Between Resin Fine Particles

The distance between resin fine particles can be determined as follows: using ultrasonic treatment to release and remove the external additives maximally, aiming to bring the particles closer to the mother toner particles. This process allows for determination of the average and standard deviation of the distance between the resin fine particles.

### Releasing of External Additive

(1): Pour 50 mL of a 5 percent by mass aqueous solution containing a surfactant (Noigen ET-165, available from DKS Co., Ltd.) into a 100 mL screw tube. Then add 3 grams of toner to the liquid mixture and gently shake it in various directions.

Subsequently, stir the liquid dispersion on a ball mill stand for 30 minutes to ensure thorough integration of the toner into the liquid dispersion.
(2): Using an ultrasonic homogenizer (model: VCX750, CV33, available from Sonics & Materials Inc.), set the output to 40 W and apply ultrasonic energy continuously for 60 minutes.

### Ultrasonic Conditions

Shaking (vibration): 60 minutes continuously
Amplitude: 40 W
Temperature at initial vibration: 23±1.5 degrees C.
Temperature during vibration: 23±1.5 degrees C.
(3): Perform suction filtration on the liquid dispersion using No. 2 qualitative filter paper (110 mm, available from Advantec Toyo Kaisha, Ltd.). Follow this filtration by rinsing twice with deionized water to remove any released (liberated) additives, and subsequently dry the obtained toner particles.
(4): Image the toner obtained in the (3) using a scanning electron microscope (SEM).

Initially, detect external additives or inorganic fillers containing Si by observing the reflected electron image.
(5): Convert the image from the (4) into binary form using an image processing software (ImageJ) to eliminate the previously detected remaining external additives and inorganic fillers.
(6): Next, observe the secondary electron image at the same positions as in the (4).

Resin fine particles are only visible in the secondary electron image, not in the reflected electron image. Compare this with the image obtained in the (5) and observe the resin fine particles present, excluding the remaining inorganic additives and fillers. Use the same image processing software to measure the distances between resin fine particles, referring to the distance between the centers of fine particles. Conduct this measuring for 100 binarized images (with one toner particle per image) and calculate the average distance between resin fine particles.

The standard deviation of the distance between resin fine particles is calculated according to the relationship below.

$$\sqrt{\frac{1}{n - 1}} {\sum }_{k = 1}^{n} ( {x}_{i} - \overline{x} ) \qquad Relationship 1$$

In Relationship 1, s represents the distance between particles.

### Imaging Condition

Scanning Electron Microscope: SU-8230 (available from Hitachi High-Technologies Corporation)
Magnification: 35,000×
Imaging Modes: SE (L) (Secondary Electrons), Backscattered Electrons (BSE)
Accelerating Voltage: 2.0 kV
Beam Current: 1.0 μA
Probe Current: Normal
Focus Mode: UHR
Working Distance (WD): 8.0 mm

The resin fine particle preferably has a volume average particle diameter of from 5 to 100 nm and more preferably from 10 to 50 nm. Resin fine particles with a volume average primary particle diameter of 5 to 100 nm improves the low temperature fixability.

The volume average primary particle diameter can be measured using a scanning electron microscope (SEM).

The resin fine particles, also referred to as resin fine particles B, preferably has a core resin (core part) and a shell resin (outer shell part) covering at least a portion of the surface of the core resin. It is more preferable that they are made of the core resin and the shell resin, and further advantageous if they contain vinyl-based units of resins b1 and b2.

The shell resin, also expressed as resin b1, and the core resin, also expressed as resin b2, preferably contain polymers obtained from homopolymerization or copolymerization of vinyl monomers.

Specific examples of the vinyl monomers include, but are not limited to, the following (1) to (10).

### (1) Vinyl Hydrocarbons

Vinyl hydrocarbons include, for example, (1-1) aliphatic vinyl hydrocarbons, (1-2) alicyclic vinyl hydrocarbons, and (1-3) aromatic vinyl hydrocarbons.

### (1-1) Aliphatic Vinyl Hydrocarbons

Aliphatic vinyl hydrocarbons include, for example, include alkenes and alkadienes.

Alkenes include, for example, ethylene, propylene, and alpha-olefins.

Alkadienes include, for example, butadiene, isoprene, 1,4-pentadiene, 1,6-hexadiene, and 1,7-octadiene.

### (1-2) Alicyclic Vinyl Hydrocarbons

Alicyclic vinyl hydrocarbons include, for example, mono- or di-cycloalkenes and alkadienes. Specific examples include, but are not limited to, (di)cyclopentadiene and terpenes.

### (1-3) Aromatic Vinyl Hydrocarbons

Aromatic vinyl hydrocarbons include, for example, styrene or its hydrocarbon (alkyl, cycloalkyl, aralkyl, and/or alkenyl) derivatives.

Specific examples include, for example, alpha-methylstyrene, 2,4-dimethylstyrene, and vinyl naphthalene.

### (2) Vinyl Monomer Containing Carboxyl Group and its Salts

The vinyl monomers containing carboxyl groups and their salts include, for example, unsaturated monocarboxylic acids (salts) and unsaturated dicarboxylic acids (salts) with carbon numbers ranging from 3 to 30, their anhydrides (salts), and monoalkyl (carbon number 1 to 24) esters or their salts.

Specific examples include, but are not limited to, (meth)acrylic acid, (anhydrous) maleic acid, maleic acid monoalkyl esters, fumaric acid, fumaric acid monoalkyl esters, crotonic acid, itaconic acid, itaconic acid monoalkyl esters, itaconic acid glycol monoethers, citraconic acid, citraconic acid monoalkyl esters, and carboxyl group-containing vinyl monomers such as cinnamic acid, including their metal salts.

In the present disclosure, the term salt refers to an acid or its salt.

For example, the term unsaturated monocarboxylic acid (salt) with carbon numbers ranging from 3 to 30 means either an unsaturated monocarboxylic acid or its salt.

In the present disclosure, (meth)acrylic signifies a methacrylic acid or acrylic acid.

(Meth)acryloyl in the present disclosure means methacryloyl or acryloyl. (Meth)acrylate in the present disclosure refers to a methacrylate or acrylate.

(3) Vinyl Based Monomer Having Sulfonic Group, Monoesterified Vinyl Sulfuric Acid, and their Salts

The vinyl monomers containing sulfonic acid groups, vinyl sulfate monoesters, and their salts include, for example, alkenesulfonic acids (salts) with carbon numbers ranging from 2 to 14, alkyl sulfonic acids (salts) with carbon numbers ranging from 2 to 24, sulfo(hydroxy)alkyl-(meth)acrylates (salts), or (meth)acrylamides (salts), and alkyl allyl sulfonates (salts).

Specifically, for alkenesulfonic acids with carbon numbers ranging from 2 to 14, examples include vinyl sulfonic acid (salt); for alkyl sulfonic acids (salts) with carbon numbers ranging from 2 to 24, examples include alpha-methylstyrene sulfonic acids (salts); and for sulfo(hydroxy)alkyl-(meth)acrylates (salts) or (meth)acrylamides (salts), examples include sulfo propyl (meth)acrylates (salts), sulfate esters (salt), or vinyl monomers containing sulfonic acid groups (salts).

### (4) Vinyl Monomer Having Phosphoric Group and its Salts

The vinyl monomers containing phosphoric acid groups and their salts include, for example, (meth)acryloyloxyalkyl (carbon number 1 to 24) phosphoric acid monoesters (salts), and (meth)acryloyloxyalkyl (carbon number 1 to 24) phosphonic acids (salts).

Specific examples of the (meth)acryloyloxyalkyl (carbon number 1 to 24) phosphoric acid monoesters (salts) include 2-hydroxyethyl (meth)acryloyloxyphosphate (salts), and phenyl-2-acryloyloxyethyl phosphate (salts).

Specific examples of the (meth)acryloyloxyalkyl (carbon number 1 to 24) phosphonic acids (salts) include 2-acryloyloxyethyl phosphonic acid and its salt.

Specific examples of the salts of the above compounds of the (2) to (4) include, but are not limited to, alkali metal salts (sodium salts, potassium salts, etc.), alkali earth metal salts (calcium salts, magnesium salts, etc.), and ammonium salts, amine salts, quaternary ammonium salts.

### (5) Hydroxyl Group-Containing Vinyl Monomer

The hydroxyl group-containing vinyl monomers include, for example, hydroxystyrene, N-methacryloyl(meth)acrylamide, hydroxyethyl (meth)acrylate, hydroxypropyl (meth)acrylate, polyethylene glycol mono(meth)acrylate, (meth)allyl alcohol, crotyl alcohol, isocrotyl alcohol, 1-butene-3-ol, 2-butene-1-ol, 2-butene-1,4-diol, propargyl alcohol, 2-hydroxyethyl propenyl ether, and sucrose allyl ether,

### (6) Nitrogen-Containing Vinyl Monomer

The nitrogen-containing vinyl monomers include, for example, (6-1) amino group-containing vinyl monomers, (6-2) amide group-containing vinyl monomers, (6-3) nitrile group-containing vinyl monomers, (6-4) quaternary ammonium cation group-containing vinyl monomers, and (6-5) nitro group-containing vinyl monomers.

For (6-1) amino group-containing vinyl monomers, one example is aminoethyl (meth)acrylate.

For (6-2) amide group-containing vinyl monomers, specific examples include, but are not limited to, (meth)acrylamide and N-methyl (meth)acrylamide.

For (6-3) nitrile group-containing vinyl monomers, specific examples include, but are not limited to, (meth)acrylonitrile, cyanostyrene, and cyanoacrylate.

For (6-4) quaternary ammonium cation group-containing vinyl monomers, specific examples include, but are not limited to, quaternized derivatives of tertiary amine-containing vinyl monomers such as dimethylaminoethyl (meth)acrylate, diethylaminoethyl (meth)acrylate, dimethylaminoethyl (meth)acrylamide, diethylaminoethyl (meth)acrylamide, using quaternizing agents such as methyl chloride, dimethyl sulfate, benzyl chloride, and dimethyl carbonate.

For (6-5) nitro group-containing vinyl monomers, one example is nitrostyrene.

### (7) Epoxy Group-Containing Vinyl Monomer

The epoxy-group-containing vinyl monomers include, for example, glycidyl (meth)acrylate, tetrahydrofurfuryl (meth)acrylate, and p-vinylphenylphenyl oxide.

### (8) Halogen Element-Containing Vinyl Monomer

The halogen element-containing vinyl monomers include, for example, vinyl chloride, vinyl bromide, vinylidene chloride, allyl chloride, chlorostyrene, bromostyrene, dichlorostyrene, chloromethylstyrene, tetrafluorostyrene, and chloroprene.

### (9) Vinyl Esters, Vinyl (Thio)Ether, and Vinyl Ketone

For vinyl esters, specific examples include, but are not limited to, vinyl acetate, vinyl butylate, vinyl propionate, vinyl butyrate, diarylphthalate, diaryladipate, isopropenyl acetate, vinylmethacrylate, methyl4-vinylbenzoate, cyclohexylmethacrylate, benzylmethacrylate, phenyl(meth)acrylate, vinylmethoxyacetate, vinylbenzoate, ethyl-α-ethoxyacrylate, alkyl (having 1 to 50 carbon atoms) (meth)acrylate such as methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, octadecyl(meth)acrylate, eicocyl(meth)acrylate), and behenyl(meth)acrylate, dialkyl fumalate (in which two alkyl groups are straight chained, branch chained, or cyclic chained groups and have 2 to 8 carbon atoms), poly(meth)aryloxyalkanes such as diaryloxyethane, triaryloxyethane, tetraaryloxyethane, tetraaryloxypropane, tetraaryloxybutane and tetrametharyloxyethane, vinyl monomers having polyalkylene glycol chain such as polyethylene glycol (molecular weight: 300) mono(meth)acrylate, polypropylene glycol (molecular weight: 500) monoacrylate, adducts of (meth)acrylate with 10 mol of methylalcoholethyleneoxide, and adducts of (meth)acrylate with 30 mol of lauryl alcohol ethylene oxide), poly(meth)acrylates such as poly(meth)acrylates of polyhydroxyl alcohols (e.g., ethylene glycol di(meth)acrylate, propylene glycol di(meth)acrylate, neopentylglycol di(meth)acrylate, trimethylol propane tri(meth)acrylate, and polyethylene glycol di(meth)acrylate).

One example of vinyl (thio)ether is vinyl methylether.

One example of vinyl ketone is vinyl methylketone

### (10) Other Vinyl Monomer

Specific examples of the other vinyl monomers include, but are not limited to, tetrafluoroethylene, fluoroacrylate, isocyanatoethyl (meth)acrylate, and m-isopropenyl-α,α-dimethylbenzyl isocyanate.

The resin b1 can be synthesized using the above-mentioned (1) to (10) vinyl monomers either individually or in combination of two or more.

As for the resin b1, copolymers of styrene with (meth)acrylic acid esters and copolymers of (meth)acrylic acid esters are preferable, with a preference to copolymers of styrene with (meth)acrylic acid esters to demonstrate good low-temperature fixability.

The incorporation of carboxylic acid into resin b1 confers acidity to the resin, aiding in the formation of toner particles with the resin fine particles (B) attached to their surface.

The vinyl monomers used in resin b2 are the same as those used in resin b1.

For the synthesis of resin b2, the aforementioned (1) to (10) vinyl monomers listed for resin b1 can be used either individually or in combination of two or more.

As for the resin b2, copolymers of styrene with (meth)acrylic acid esters and copolymers of (meth)acrylic acid esters are preferable, with a preference to copolymers of styrene with (meth)acrylic acid esters to demonstrate good low-temperature fixability.

At a frequency of 1 Hz and 100 degrees C., the loss elastic modulus G′ of the viscoelasticity for resin b1 is preferably between from 1.5 to 100 MPa, more preferably from 1.7 to 30 MPa, and even more preferably from 2.0 to 10 MPa.

For resin b2 at a frequency of 1 Hz and 100 degrees C., the loss elastic modulus G″ of the viscoelasticity is preferably from 0.01 to 1.0 MPa, more preferably from 0.02 to 0.5 MPa, and even more preferably from 0.05 to 0.3 MPa.

If the loss elastic moduli G′ and G″ of the viscoelasticity fall within these ranges, resin fine particles (B) containing components of resin b1 and resin b2 within the same particle are more likely to form toner particles with resin fine particles (B) attached to their surface.

At a frequency of 1 Hz and 100 degrees C., the loss elastic modulus G′ and G″ of viscoelasticity for resins b1 and b2 can be adjusted by altering the types and proportions of constituent monomers, or by adjusting polymerization conditions (such as initiator types and quantities, chain transfer agent types and amounts, and reaction temperature).

Specifically, it is feasible to adjust each G′ and G″ within the previously mentioned ranges by composing formulations as follows:
(1) The glass transition temperature Tg1 calculated from the constituent monomers of resin b1 and the glass transition temperature Tg2 calculated from the constituent monomers of resin b1 are preferably: Tg1 preferably from 0 to 150 degrees C., more preferably from 50 to 100 degrees C., and Tg2 preferably from −30 to 100 degrees C., more preferably from 0 to 80 degrees C., and most preferably from 30 to 60 degrees C.

The glass transition temperature Tg calculated from the constituent monomers is a value derived using the Fox method.

The Fox method [T. G. Fox, Phys. Rev., 86, 652 (1952)] is a method of estimating the Tg of copolymers from the Tg of individual homopolymers, as shown in the following equation:

1/Tg=(W1/Tg1)+(W2/Tg)+ . . . +(Wn/Tgn)

In the equation, Tg represents the glass transition temperature (in absolute temperature) of the copolymer, Tg1, Tg2 . . . Tgn represent the glass transition temperatures (in absolute temperature) of the individual monomer components, and W1, W2 . . . Wn represent the weight fractions of each monomer component.
(2) The calculated acid values AV1 of resin b1 and AV2 of resin b2 are preferred as follows: AV1 preferably between from 75 to 400 mg KOH/g, more preferably from 150 to 300 mg KOH/g, and AV2 preferably from 0 to 50 mg KOH/g, more preferably from 0 to 20 mg KOH/g, and most preferably 0 mg KOH/g.

The calculated acid value is the theoretical acid value derived from the molar quantity of the acidic groups contained in the constituent monomers and the total weight of the constituent monomers.

As constituent monomers meeting the conditions 1 and 2, for resin b1, for example, the compositions include styrene preferably in the range of 10 to 80 percent by mass and more preferably 30 to 60 percent by mass, and methacrylic acid and/or acrylic acid preferably in a combined range of 10 to 60 percent by mass and more preferably 30 to 50 by mass based on the total mass of resin b1.

Similarly, for resin b2, for example, compositions include styrene preferably in the range of 10 to 100 percent by mass, more preferably 30 to 90 percent by mass based on the total mass of resin b2, and methacrylic acid and/or acrylic acid in resin b2 preferably in a combined range of 0 to 7.5 percent by mass and more preferably 0 to 2.5 percent by mass based on the total mass of methacrylic acid and/or acrylic acid.
(3) Adjust the polymerization conditions (such as types and amounts of initiators, chain transfer agents, and reaction temperatures). Specifically, regarding the number average molecular weights Mn1 and Mn2 of resin b1 and resin b2 respectively, Mn1 preferably ranges from 2,000 to 2,000,000, more preferably from 20,000 to 200,000. Mn2 is preferably from 1,000 to 1,000,000 and more preferably from 10,000 to 100,000.

In the present disclosure, the loss elastic modulus G′ and G″ of viscoelasticity are measured, for example, using the following viscoelastic measuring device.
Device: ARES-24A (available from Rheometric Scientific)
Jig: 25 mm parallel plate
Frequency: 1 Hz
Strain rate: 10 percent
Heating speed: 5 degrees C./min

The acid value AVb1 of resin b1 is preferably from 75 to 400 mg KOH/g, with 150 to 300 mg KOH/g being more preferable.

Within this range of acid values, toner particles are easily formed, and these particles have resin fine particles (B) attached to their surface. These fine particles contain vinyl-based units that contain resin b1 and resin b2 within the same particle.

Resin b1 within the specified acid value range of resin b1 preferably contains methacrylic acid and/or acrylic acid in the range of from 10 to 60 percent by mass and more preferable from 30 to 50 percent by mass based on the total mass of resin b1.

The acid value AVb2 for resin b2 is preferably from 0 to 50 mg KOH/g, more preferably from 0 to 20 mg KOH/g, and most preferably 0 mg KOH/g to demonstrate good low-temperature fixability.

Resin b2 within the specified acid value range of resin b2 preferably contains methacrylic acid and/or acrylic acid in the range of from 0 to 7.5 percent by mass and more preferably from 0 to 2.5 percent by mass based on the total mass of resin b1.

Acid value can be measured, for example, according to the measuring method according to JIS K0070:1992 (Test methods for acid value, saponification value, ester value, iodine value, hydroxyl value and unsaponifiable matter of chemical products) format.

It is preferred that the glass transition temperature of resin b1 be higher than that of resin b2, by at least 10 degrees C., and even more favorably, by 20 degrees C.

This preference helps to strike a balance between the ease of forming toner particles with resin fine particles (B) adhering to the toner particle surfaces and the low-temperature fixability of the toner particles in the present disclosure.

The range of the glass transition temperature (referred to as Tg) of resin b 1 is preferably from 0 to 150 degrees C. and more preferably from 50 to 100 degrees C.

A Tg at or above 0 degrees C. enhances heat-resistant storage stability, while staying at or below 150 degrees C. minimizes compromise of the low-temperature fixability.

Resin b2 preferably has a Tg range of from −30 to 100 degrees C., more preferably 0 to 80 degrees C., and even more preferably 30 to 60 degrees C.

A Tg at or above −30 degrees C. enhances heat-resistant storage stability, and staying below at or 100 degrees C. minimizes inhibition of low-temperature fixability.

The Tg in the present disclosure is measured using the DSC 20, SSC/580, available from Seiko Instruments Inc., following the method outlined in ASTM D3418-82 (Standard Test Method for Transition Temperatures and Enthalpies of Fusion and Crystallization of Polymers by Differential Scanning calorimetry).

The solubility parameter (SP) value of resin b1 is preferably from 9 to 13 (cal/cm³)^{1/2}, more preferably from 9.5 to 12.5 (cal/cm³)^{1/2}, and even more preferably from 10.5 to 11.5 (cal/cm³)^{1/2} for ease of toner particle formation.

The SP value of resin b1 can be adjusted by changing the types and proportions of the constituent monomers.

The SP value of resin b2 is preferably from 8.5 to 12.5 (cal/cm³)^{1/2}, more preferably from 9 to 12 (cal/cm³)^{1/2}, and even more preferably from 10 to 11 (cal/cm³)^{1/2} for ease of toner particle formation.

The SP value of resin b2 can be adjusted by changing the types and proportions of the constituent monomers.

The SP value in the present disclosure is calculated using the method proposed by Fedors [Polym. Eng. Sci. 14 (2) 152, (1974)].

Resin b1 preferably contains 10 to 80 percent by mass of styrene as constituent units and more preferably 30 to 60 percent by mass based on the total mass of resin b1 considering the Tg of resin b1 and its copolymerization compatibility with other monomers.

Resin b2 preferably contains 10 to 100 percent by mass of styrene as constituent units and more preferably 30 to 90 percent by mass based on the total mass of resin b2 considering the Tg of resin b2 and its copolymerization compatibility with other vinyl monomers.

The number average molecular weight Mn of resin b1 is preferably from 2,000 to 2,000,000 and more preferably from 20,000 to 200,000. A number average molecular weight of 2,000 or greater enhances heat-resistant storage stability, and a number average molecular weight of 2,000,000 or less minimizes inhibition of low-temperature fixability.

The weight-average molecular weight Mw1 of resin b1 is preferably greater than Mw2 of resin b2, even more preferably at least 1.5 times larger than Mw2, and furthermore preferably at least 2.0 times larger than Mw2. Within this range, it is easy to strike a balance between ease of forming toner particles and low-temperature fixability.

The weight average molecular weight Mw1 of the resin b1 is preferably from 20,000 to 20,000,000 and more preferably from 200,000 to 2,000,000. An Mw1 of 20,000 or greater enhances heat-resistant storage stability, while an MW1 of 20,000,000 or less minimizes inhibition of low-temperature fixability.

The number average molecular weight Mn2 of resin b2 is preferably from 1,000 to 1,000,000 and more preferably from 10,000 to 100,000. An Mn2 of 1,000 or greater enhances heat-resistant storage stability of toner, while an Mn2 of 1,000,000 or less minimizes inhibition of low-temperature fixability.

The weight average molecular weight Mw2 of resin b2 is preferably from 10,000 to 100,000, more preferably from 100,000 to 1,000,000 and furthermore preferably from 100,000 to 500,000. An Mw2 of 10,000 or greater enhances heat-resistant storage stability of toner, while an Mn2 of 10,000,000 or less minimizes inhibition of low-temperature fixability.

Of these, it is preferable that Mw1 of resin b1 be from 200,000 to 2,000,000 and Mw2 of resin b2 be from 100,000 to 500,000 and Mw1 of resin b1>Mw2 of resin b2.

The number average molecular weight Mn and the weight average molecular weight Mw can be measured with gel permeation chromatography (GPC) under the following conditions:
An example of device: HLC-8120, available from TOSOH CORPORATION
An example of column: TSK GEL GMH6, available from TOSOH CORPORATION, two columns
Measuring temperature: 40 degrees C.
Sample solution: 0.25 percent by mass tetrahydrofuran solution (non-dissolved portion filtered with glass filter)
Amount of solution infused: 100 μL
Detector: Refractive index detector
Reference materials: Standard polystyrene (TSK standard polystyrene) with 12 materials (molecular weights: 500, 1,050, 2,800, 5,970, 9,100, 18,100, 37,900, 96,400, 190,000, 355,000, 1,090,000, and 2,890,000) [available from TOSOH CORPORATION]

The mass ratio of resin b1 to resin b2 in resin fine particles B is preferably from 5/95 to 95/5, more preferably from 25/75 to 75/25, and even more preferably from 40/60 to 60/40. When the mass ratio between resin b1 and resin b2 is 5/95 or higher, it enhances the heat resistance of the toner, and when the mass ratio is 95/5 or lower, it is more likely to form toner particles with resin fine particles B attached to their surface.

Methods of producing resin fine particles B include known manufacturing techniques, for example, the following methods (I) through (V):
(I) Method involving seed polymerization of resin b2 monomers using fine particles of resin b1 in an aqueous dispersion as seeds.
(II) Method involving seed polymerization of resin b1 monomers using fine particles of resin b2 in an aqueous dispersion as seeds.
(III) Method of emulsifying a mixture of resin b1 and resin b2 in an aqueous medium to obtain an aqueous dispersion of resin fine particles.
(IV) Method involving emulsifying a mixture of constituent monomers of resin b1 and resin b2 in an aqueous medium followed by polymerization of the constituent monomers of resin b2 to obtain an aqueous dispersion of resin fine particles.
(IV) Method involving emulsifying a mixture of constituent monomers of resin b2 and resin b1 in an aqueous medium followed by polymerization of the constituent monomers of resin b1 to obtain an aqueous dispersion of resin fine particles.

The shell resin b1 and core resin b2 as constitutive components within the same particle of resin fine particles B can be identified by observing the cross-section of resin fine particles B cut with surface element analysis equipment such as TOF-SIMS, EDX-SEM, and similar devices for observing elemental mapping images, as well as by examining an electron microscope image of the cross-section of resin fine particles B stained with dyes specific to functional groups present in resin b1 and resin b2.

Additionally, resin fine particles obtained by these methods may contain resin fine particles B with constitutive components of resin b1 and resin b2 within the same particle, alongside mixtures containing resin fine particles composed exclusively of resin b1 or resin b2. In the subsequent composite processes described later, the mixture can be used as is, or resin fine particles B alone can be isolated and utilized.

Specific examples of the (I) mentioned above include methods such as dropwise polymerization of the constitutive monomers of resin b1 for producing an aqueous dispersion of resin fine particles containing resin b1, followed by using this dispersion as a seed for seed polymerization of the constitutive monomers of resin b2, as well as a method of preparing resin b1 through solution polymerization, emulsifying and dispersing it in water, then utilizing this emulsion as a seed for the seed polymerization of the constitutive monomers of resin b2.

Specific examples of the (II) mentioned above include, but are not limited to, a method such as dropwise polymerization of the constitutive monomers of resin b2 for producing an aqueous dispersion of resin fine particles containing resin b2, followed by using this dispersion as a seed for seed polymerization of the constitutive monomers of resin b1, as well as a method of preparing resin b2 through solution polymerization, emulsifying and dispersing it in water, then utilizing this emulsion as a seed for the seed polymerization of the constitutive monomers of resin b1.

One specific example of the (III) mentioned above involves mixing solutions or melts of pre-produced resins b1 and b2 from prior solution polymerization and then emulsifying and dispersing this mixture in an aqueous medium.

Specific examples of the (IV) mentioned above include, but are not limited to, a method of mixing resin b1 preliminarily prepared via prior solution polymerization with the constitutive monomers of resin b2, emulsifying and dispersing this mixture in an aqueous medium, and polymerizing the constitutive monomers of resin b2, as well as a method of manufacturing resin b1 in the constitutive monomers of resin b2, emulsifying and dispersing this mixture in an aqueous medium, and subsequently polymerizing the constitutive monomers of resin b2.

Specific examples of the (V) mentioned above include, but are not limited to, a method of mixing resin b2 preliminarily prepared via prior solution polymerization with the constitutive monomers of resin b1, emulsifying and dispersing this mixture in an aqueous medium, and polymerizing the constitutive monomers of resin b1, as well as a method of manufacturing resin b2 in the constitutive monomers of resin b1, emulsifying and dispersing this mixture in an aqueous medium, and subsequently polymerizing the constitutive monomers of resin b1.

In the present disclosure, any method of the above-mentioned (I) to (V).

Resin fine particle B is preferably used as an aqueous dispersion.

The material (aqueous medium) used in the above-mentioned aqueous dispersion, as long as it dissolves in water, is not particularly limited and can be selected appropriately to suit to a particular application. Examples include, but are not limited to, surfactants D, buffering agents, and protective colloids. These can be used alone or in combination.

For the aqueous medium used in the above-mentioned aqueous dispersion, any liquid that requires water can be utilized without specific restrictions. For example, this medium includes a solution containing water.

### Other Components

The other components are not specifically limited and can be appropriately selected to suit to a particular application. These include, for example, release agents, colorants, polymers (prepolymers) containing sites reactive with compounds having active hydrogen groups, compounds containing active hydrogen groups, charge control agents, flow improvers, cleaning improvers, and magnetic materials.

### Release Agent

The release agent, or wax, is not particularly limited. It can be suitably selected from the known monomers.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum.

In addition to these natural waxes, synthesis hydrocarbon waxes such as Fischer-Tropsch wax and polypropylene wax and synthesis wax such as ester, ketone, and ether are also usable.

Furthermore, aliphatic acid amide-based compounds, such as 12-hydroxystearic acid amide, stearic acid amide, phthalic acid anhydride imide, and chlorinated hydrocarbons; crystalline polymer resins having a low molecular weight such as homo polymers, for example, poly-n-stearylic methacrylate and poly-n-lauryl methacrylate, and copolymers (for example, copolymers of n-stearyl acrylate-ethylmethacrylate); and crystalline polymer having a long alkyl group in the branched chain are also usable.

Of these, hydrocarbon waxes such as paraffin wax, microcrystalline wax, Fischer-Tropsch wax, polyethylene wax, and polypropylene wax are preferred.

The melting point of the release agent is not particularly limited and can be suitably selected to suit to a particular application. It is preferably from 60 to lower than 95 degrees C.

As for the release agent, it is more preferable for it to be a hydrocarbon wax with a melting point of 60 to below 95 degrees C. Such a release agent effectively functions at the interface between the fixing roller and the toner, enhancing high-temperature offset resistance without an application of oil or similar agents to the fixing roller.

Particularly, hydrocarbon waxes, due to their limited compatibility with the polyester resin, can function independently, ensuring no compromise on the softening effect of the crystalline polyester resin and the offset resistance of the release agent.

With a melting point at or above 60 degrees C., the release agent remains less molten at lower temperatures, ensuring good heat-resistant storage stability of the toner. When the melting point of the release agent is below 95 degrees C., it melts sufficiently by heating during fixing, guaranteeing adequate offset resistance.

The proportion of the release agent is not particularly limited and can be suitably selected to suit to a particular application. The number of parts of the release agent is preferably from 2 to 10 parts by mass and more preferably from 3 to 8 parts by mass to 100 parts of the toner. A release agent at two or more parts by mass prevents the hot high-temperature offset resistance and low temperature fixability from lowering. A release agent at 10 or less parts by mass is likely to prevent heat-resistant storage stability from lowering and reduces the chance of fogging in an image obtained.

Within the more preferable range, it is advantageous to excel in high image quality and fixing stability.

### Colorant

The colorant has no particular limit and can be suitably selected to suit to a particular application.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures thereof.

The proportion of the colorant is not particularly limited and can be suitably selected to suit to a particular application. The number of parts of the colorant is preferably from 1 to 15 parts by mass and more preferably from 3 to 10 parts by mass to 100 parts by mass of the toner mentioned above.

The colorant can be used with a resin as a composite master batch. Specific examples of the resins for use in manufacturing a master batch or the resins to be kneaded with a master batch include, but are not limited to, the hybrid resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, and paraffin waxes. These can be used alone or in combination.

The master batch for use in the toner of the present disclosure is typically prepared by mixing and kneading a resin and a coloring agent upon application of high shear stress thereto. In this case, an organic solvent can be used to boost the interaction between the colorant and the resin. In the flushing method, an aqueous paste including water of a colorant is mixed with a resin and an organic solvent to transfer the coloring agent to the resin solution and then the aqueous liquid and organic solvent are removed. This method is preferably used because the resulting wet cake of the colorant can be used as it is. In this case, a high shear dispersion device such as a three-roll mill can be preferably used for kneading the mixture.

Polymer (Prepolymer) Having Site Reactive with Compound Having Active Hydrogen Group

Polymers having a site reactive with a compound having active hydrogen groups (hereinafter referred to as prepolymer) are not particularly limited and can be suitably selected to suit to a particular application. Specific examples include, but are not limited to, polyol resins, polyacrylic resins, polyester resins, epoxy resins and derivatives thereof. These can be used alone or in combination. Of these, polyester resins are preferable in terms of high flowability and transparency during melting.

Specific examples of the site in the prepolymer that is reactive with a compound having an active hydrogen group include, but are not limited to, functional groups such as epoxy groups, carboxyl groups, and functional groups represented by —COCl. These can be used alone or in combination. Of these, an isocyanate group is particularly preferable.

The prepolymer is not particularly limited and can be suitably selected to suit to a particular application. It is preferred to use a polyester resin having, for example, an isocyanate group, which can produce a urea linkage because the molecular weight of a polymer component can be easily controlled and oil-free low temperature fixability and releasability of a dry toner can be ensured even in the case that there is no releasing oil application mechanism to a heating medium for fixing.

### Compound Having Active Hydrogen Group

The compound having an active hydrogen group serves as an elongation agent, cross-linking agent, and similar agents in the reaction such as elongation reaction and cross-linking reaction of the polymer having a portion reactive with a compound having active hydrogen groups in an aqueous medium.

The active hydrogen group has no particular limit and can be suitably selected to suit to a particular application. For example, hydroxyl group (alcoholic hydroxyl group or phenolic hydroxyl group), amino group, carboxyl group, and mercapto group can be listed. These can be used alone or in combination.

The compound having an active hydrogen group is not particularly limited and compound having an active hydrogen group. However, when the polymer having a site reactive with a compound having active hydrogen groups is a polyester resin having an isocyanate group, amines are preferable for their ability to elevate the molecular weight through elongation and cross-linking reactions with the polyester resin. This amine is not particularly limited and can be suitably selected to suit to a particular application. Specific examples include, but are not limited to, diamines, amines with three or more valences, amino alcohols, amino mercaptans, amino acids, and their blocked derivatives. These can be used alone or in combination.

Of these, diamine and a mixture of diamine with a minute amount of polyamines having three or more amino groups are preferable.

The diamines are not particularly limited and can be chosen as appropriate for the purpose, such as aromatic diamines, cycloaliphatic diamines, aliphatic diamines, and more. There are no specific limitations on aromatic diamines, and they can be selected as appropriate for the purpose. Examples include, but are not limited to, phenylenediamines, diethyltoluenediamines, and 4,4′-diaminodiphenylmethane. Similarly, there are no particular restrictions on cycloaliphatic diamines, and they can be selected based on the intended purpose. Examples include, but are not limited to, 4,4′-diamino-3,3′-dimethyl-dicyclohexylmethane, diaminocyclohexane, and isophoronediamine. For aliphatic diamines, there are no specific limitations, and they can be chosen according to the intended purpose. Examples include, but are not limited to, ethylenediamine, tetramethylenediamine, and hexamethylenediamine.

As for the trivalent or higher amines, there are no specific restrictions, and they can be selected as needed for the purpose. Examples include, but are not limited to, diethylenetriamine and triethylenetetramine,

The amino alcohols are not specifically restricted and can be chosen as needed for the purpose. Examples include, but are not limited to, ethanolamine and hydroxyethyl aniline.

Similarly, the amino mercaptans are not specifically restricted and can be chosen to suit to a particular application. Examples include, but are not limited to, aminoethyl mercaptan, and aminopropyl mercaptan.

The amino acids are not specifically restricted and can be chosen as needed for the purpose. Examples include, but are not limited to, aminopropionic acid and aminocaproic acid.

Similarly, for the blocked derivatives, there are no specific restrictions, and they can be chosen as needed for the purpose.

Specific examples include, but are not limited to, ketimine compounds and oxazoline compounds prepared by blocking an amino group with a ketone such as acetone, methyl ethyl ketone and methyl isobutyl ketone,

### Polyester Resin Containing Isocyanate Group

There are no specific restrictions for polyester resins containing isocyanate groups, also referred to as polyester prepolymers containing isocyanate groups, and they can be chosen as needed for the purpose. A specific example is a reaction product of a polyisocyanate with a polyester resin with active hydrogen groups obtained by polycondensing a polyol and polycarboxylic acid.

### Polyol

There are no specific restrictions for the polyols, and they can be chosen as needed for the purpose. Examples include, but are not limited to, diols, tri- or higher valent alcohols, mixtures of diols and tri- or higher valent alcohols. These can be used alone or in combination.

Of these, diol and mixtures of diol with a minute amount of tri- or higher valent alcohol are preferable.

The diols are not particularly limited and can be suitably selected to suit to a particular application.

Specific examples of include, but are not limited to, alkylene glycols such as ethylene glycol, 1,2-propylene glycol, 1,3-propylene glycol, 1,4-butanediol and 1,6-hexanediol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. There is no specific limitation to the number of carbon atoms of the alkylene glycol and it can be suitably selected to suit to a particular application. It is preferably from 2 to 12.

Of these, an alkylene glycol or an adduct of a bisphenol with an alkylene oxide having 2 to 12 carbon atoms are preferable. An adduct of a bisphenol with an alkylene oxide and a mixture of an adduct of a bisphenol with an alkylene oxide and an alkylene glycol having a 2 to 12 carbon atoms are more preferable.

This tri- or higher-valent alcohol is not particularly limited and can be suitably selected to suit to a particular application. It includes a tri- or higher-valent aliphatic alcohol, a tri- or higher-valent polyphenol, and an adduct of polyphenol with alkylene oxide.

There is no specific limit for tri- or higher-valent aliphatic alcohols, and they can be chosen as needed for the purpose. Examples include, but are not limited to, glycerin, trimethylolethane, trimethylolpropane, pentaerythritol, and sorbitol.

Similarly, for trivalent or higher-valent polyphenols, there are no specific restrictions, and they can be chosen as needed for the purpose. Examples include, but are not limited to, trisphenol PA, phenol novolac, and cresol novolac.

Specific examples of the adduct of polyphenols with tri- or higher-valent alkylene oxide include, but are not limited to, an adduct of tri- or higher polyphenol with alkylene oxide such as ethylene oxide, propylene oxide, and butylene oxide.

When using a mixture of a diol and a trivalent or higher-valent alcohol, there are no specific restrictions on the mass ratio of trivalent or higher alcohols to diols, and they can be chosen as needed for the purpose. However, a range of 0.01 to 10 percent by mass is preferable, with 0.01 to 1 percent being more preferable depending on the purpose.

### Polycarboxylic Acid

There is no specific limitation to polycarboxylic acid and it can be suitably selected to a particular application. Examples include, but are not limited to, a dicarboxylic acid, trivalent or higher-valent carboxylic acid, and a mixture of a dicarboxylic acid and a trivalent or higher-valent carboxylic acid. These can be used alone or in combination.

Of these, a dicarboxylic acid or a mixture of a dicarboxylic acid with a small amount of a trivalent or higher-valent carboxylic is preferable.

The dicarboxylic acid is not particularly limited and can be suitably selected to suit to a particular application. For example, it can include, but is not limited to, alkanoic dicarboxylic acids, alkenoic dicarboxylic acids, and aromatic dicarboxylic acids, and more.

Alkanoic dicarboxylic acids are not specifically restricted and can be chosen as needed for the purpose. Examples include, but are not limited to, succinic acid, adipic acid, and sebacic acid.

Similarly, there is no specific restriction for alkenoic dicarboxylic acid and it can be suitably selected to suit to a particular application. It is preferably an alkenoic dicarboxylic acid with carbon chains ranging from 4 to 20. For alkenoic dicarboxylic acids with carbon chains ranging from 4 to 20, there are no specific restrictions, and they can be chosen as needed for the purpose. Examples include, but are not limited to, maleic acid and fumaric acid.

Aromatic dicarboxylic acids are not specifically restricted and can be chosen as needed for the purpose, but aromatic dicarboxylic acids with carbon chains ranging from 8 to 20 are preferable. For aromatic dicarboxylic acids with carbon chains ranging from 8 to 20, there are no specific restrictions, and they can be chosen as needed for the purpose. Examples include, but are not limited to, phthalic acid, isophthalic acid, terephthalic acid, and naphthalenedicarboxylic acid.

The trivalent or higher-valent carboxylic acid is not particularly limited and can be suitably selected to suit to a particular application. It includes a trivalent or higher-valent aromatic carboxylic acid.

The trivalent or higher-valent carboxylic acid is not particularly limited and can be suitably selected to suit to a particular application. It includes trivalent or higher-valent aromatic carboxylic acid. The trivalent or higher-valent aromatic carboxylic acid with a carbon chain length of 9 to 20 is not particularly limited and can be suitably selected to suit to a particular application. It includes, but is not limited to, trimellitic acid and pyromellitic acid.

Specific examples of the polycarboxylic acids include, but are not limited to, acid anhydrides or lower alkyl esters of any of dicarboxylic acids, tri- or higher carboxylic acids, and mixtures of dicarboxylic acids and tri- or higher carboxylic acids.

The lower alkyl ester is not particularly limited and can be suitably selected to suit to a particular application. Examples include, but are not limited to, methyl esters, ethyl esters, and isopropyl esters.

When using a mixture of dicarboxylic acids and trivalent or higher-valent carboxylic acids, there are no specific limitations on the mass ratio of a trivalent or higher-valent carboxylic acid to a dicarboxylic acid, and they can be suitably selected to suit to a particular application. However, a mass ratio of 0.01 to 10 percent by mass is preferable, with 0.01 to 1 percent by mass being more preferable.

When conducting the polycondensation between the polyol and the polycarboxylic acid, there are no specific limitations on the equivalent ratio between the hydroxyl groups of the polyol and the carboxyl groups of the polycarboxylic acid. It can be suitably selected to suit to a particular application. However, a ratio of 1:1 to 2:1 is preferable, with 1:1 to 1.5:1 being more preferable, and particularly favorable between 1.02:1 to 1.3:1.

There are no specific restrictions on the content of structural units derived from the polyol in the polyester prepolymer with isocyanate groups, and it can be suitably selected to suit to a particular application. However, a content of 0.5 to 40 percent by mass is preferable, with 1 to 30 percent by mass being more preferable, and particularly favorable from 2 to 20 percent by mass.

When the content is 0.5 or higher percent by mass, the toner maintains a balance between the heat-resistant storage stability and low-temperature fixability, ensuring high-temperature offset resistance. Also, the toner can retain the low-temperature fixability below 40 percent by mass.

### Polyisocyanate

Examples include, but are not limited to, aliphatic diisocyanates, cycloaliphatic diisocyanates, aromatic diisocyanates, aromatic-aliphatic diisocyanates, and isocyanurates, as well as derivatives blocked with phenolic compounds, oximes, caprolactam, or the like.

The aliphatic diisocyanate is not particularly limited and can be suitably selected to suit to a particular application.

Specific examples of the aliphatic di-isocyanates include, but are not limited to, tetramethylene diisocyanate, hexamethylene diisocyanate and 2,6-diisocyanate methylcaproate, octamethylene diisocyanate, decamethylene diisocyanate, dodecamethylene diisocyanate, tetradecamethylene diisocyanate, trimethyl hexane diisocyanate, and tetramethyl hexane diisocyanate.

The alicyclic diisocyanate is not particularly limited and can be suitably selected to suit to a particular application.

Specific examples include, but are not limited to, isophorone diisocyanate and dicyclohexylmethane diisocyanate.

The aromatic diisocyanate is not particularly limited and can be suitably selected to suit to a particular application.

Specific examples include, but are not limited to, tolylene diisocyanate, diphenylmethane diisocyanate, 1,5-naphthylene diisocyanate, 4,4-diisocyanate-3,3′-dimethyldiphenyl, 4,4′-diisocyanate-3-methyl diphenylmethane, and 4,4′-diisocyanate-diphenyl ether.

There is no specific limitation to the aromatic-aliphatic diisocyanates, and they can be chosen as needed for the purpose. An example is α, α, α′, α′-tetramethylxylylene diisocyanate. Similarly, for isocyanurate compounds, there are no specific restrictions, and they can be chosen as needed for the purpose. Examples include, but are not limited to, tris(isocyanatoalkyl) isocyanurates and tris(isocyanatocycloalkyl) isocyanurates. These can be used alone or in combination.

When the polyisocyanulate is caused to react with a polyester resin having a hydroxyl group, the equivalent ratio (i.e., [NCO]/[OH]) of the polyisocyanate's isocyanate group to the polyester resin's hydroxyl group is not particularly limited and can be suitably selected to suit to a particular application. It varies preferably from 1 to 5, more preferably from 1.2 to 4 and particularly preferably from 1.5 to 3. When this ratio reaches 1 or higher, the toner can retain the offset resistance. Conversely, a ratio of 5 or less does not compromise the toner's low-temperature fixability.

There are no specific restrictions on the content of structural units derived from the polyisocyanate in the polyester prepolymer with isocyanate groups, and it can be suitably selected to suit to a particular application. However, a content of 0.5 to 40 percent by mass is preferable, with 1 to 30 percent by mass being more preferable, and particularly favorable from 2 to 20 percent by mass. When this ratio reaches 0.5 or higher, the toner can retain the high temperature offset resistance. Conversely, a ratio of 40 or less does not compromise the toner's low-temperature fixability.

There are no specific restrictions on the average number of isocyanate groups per molecule of a polyester prepolymer having the isocyanate group is not particularly limited and can be suitably selected to suit to a particular application. It is preferably 1 or higher, more preferably from 1.2 to 5, and particularly preferably from 1.5 to 4. When the average is at or above 1, the molecular weight of urea-modified polyester resin does not decrease, and the high temperature offset resistance does not deteriorate.

The mass ratio of a polyester prepolymer having an isocyanate group to a polyester resin containing an adduct of bisphenol with propylene oxide in an amount of 50 or more mol percent in the polyol component mentioned above with a particular hydroxyl value and an acid value is not particularly limited and can be suitably selected to suit to a particular application. It is preferably from less than 5/greater than 95 to greater than 25/less than 75 and more preferably from 10/90 to 25/75. When the mass ratio is at or above less than 5/greater than 95, the high temperature offset resistance does not deteriorate, and when it is at or below greater than 25/less than 75, the low-temperature fixability and the glossiness of the image do not deteriorate.

### Charge Control Agent

There is no specific limitation to the selection of the charge control agent and it can be suitably selected to suit to a particular application.

Specific examples include, but are not limited to, nigrosine dyes, triphenylmethane dyes, chrome containing metal complexes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid and metal salts of salicylic acid derivatives.

Specific examples include, but are not limited to, BONTRON 03 (nigrosine dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, and a quaternary ammonium group.

The proportion of the charge control agent is not particularly limited and can be suitably selected to suit to a particular application. The number of parts by mass of the charge control agent is preferably from 0.1 to 10 parts by mass and more preferably from 0.2 to 5 parts by mass to 100 parts by mass of the toner. If the content is at 0.1 parts by mass or above, it is possible to reliably impart static charge. If it is 10 or less parts by mass, the electrostatic charge of the toner does not become excessively high, maintaining the effectiveness of the main charge control agent and the appropriately sized electrostatic attraction force with the development roller. These effects and force help to mitigate the decrease in fluidity of the developer and the reduction in the image density.

These charge control agents can be melt-kneaded with masterbatches and resins, then dissolved and dispersed afterward. They can also be directly dissolved or dispersed in organic solvents, and may be applied and fixed onto the toner surface after toner particle preparation.

As for the acid value of the toner, there is no specific restriction and can be appropriately selected to suit to a particular application. However, for controlling the low-temperature fixability (minimum fixing temperature) and hot offset occurrence temperature, it is preferable for the acid value to range from 0.5 to 40 mg KOH/g. An acid value of 0.5 or higher mg KOH/g improves the dispersion stability during manufacturing due to the base used. Additionally, this acid value range results in lesser progression of elongation and/or cross-linking reactions when the prepolymer is employed, ensuring good manufacturing stability. An acid value of 40 or lower mgKOH/g ensures sufficient elongation and/or cross-linking reactions when the prepolymer is used, preventing a decrease in heat-resistant offset property.

As for the glass transition temperature Tg of the toner, there are no specific restrictions and it can be appropriately selected to suit to a particular application. However, it is preferable that the glass transition temperature Tg1st, which is calculated during the first heating cycle in DSC measurements, be from 45 to below 65 degrees C. and more preferably from 50 to 60 degrees C. This Tg1st range allows for achieving low-temperature fixability, heat resistant storage stability, and high durability. When Tg1st is at 45 degrees C. or above, the occurrences of blocking inside a developing machine and filming onto the photoconductor are avoided, and when it is below 65 degrees C., the low-temperature fixability remains uncompromised.

The glass transition temperature Tg2nd, calculated during the second heating cycle in DSC measurements of the toner, is preferably from 20 to below 40 degrees C. When Tg2nd is 20 or higher degrees C., the occurrences of blocking inside a developing unit and filming onto the photoconductor are avoided. When it is below 40 degrees C., the low-temperature fixability remains uncompromised.

There are no specific restrictions on the volume average particle size of the toner and it can be appropriately selected to suit to a particular application. However, it is preferable for the volume average particle size to be from 3 to below 7 μm.

Additionally, it is desirable for the ratio of the volume average particle size to the number average particle size to be 1.2 or less.

Moreover, it is preferable to contain components with a volume average particle size of 2 or less μm in an amount of 1 to 10 number percent.

### Method of Measuring Acid Value and Hydroxyl Value

The hydroxyl value can be measured using the method conforming to JIS K0070-1966 (Test methods for acid value, saponification value, ester value, iodine value, hydroxyl value and unsaponifiable matter of chemical products) format.

Specifically, 0.5 g of the sample is precisely weighed into a 100 mL measuring flask, to which 5 mL of acetylation reagent is added. Subsequently, the flask is heated for 1 to 2 hours in a water bath at 100±5 degrees C. and then allowed to naturally cool after removal from the bath. Water is then added, and the flask is shaken to decompose anhydrous acetic acid. To ensure complete decomposition of anhydrous acetic acid, the flask is heated again in the water bath for over 10 minutes and allowed to naturally cool, followed by thoroughly rinsing the flask walls with an organic solvent.

Furthermore, using a potentiometric automatic titration device DL-53 Titrator (available from Mettler Toledo International Inc.) and electrode DG113-SC (available from Mettler Toledo International Inc.), the hydroxyl value is measured at 23 degrees C., and analyzed using LabX Light Version 1.00.000 software. For calibration of the equipment, a mixed solvent of 120 mL of toluene and 30 mL of ethanol is used.

The measuring conditions are as follows.

Measuring Conditions

```
Stir
  Speed [%]: 25
  Time [s]: 15
EQP titration
  Titrant/Sensor
    Titrant CH₃ONa
    Concentration [mol/L]: 0.1
    Sensor: DG115
    Unit of measuring m V
  Predispensing to volume
    Volume [mL]: 1.0
    Wait time [s]: 0
  Titrant addition Dynamic
    dE (set) [mV]: 8.0
    dV (min) [mL]: 0.03
    dV (max) [mL]: 0.5
  Measure mode: Equilibrium controlled
  dE [mV]: 0.5
    dt [s]: 1.0
    t (min) [s]: 2.0
    t (max) [s]: 20.0
  Recognition
    Threshold: 100.0
    Steepest jump only: No
    Range: No
    Tendency: None
  Termination
    At maximum volume [mL]: 10.0
    At potential: No
    At slope: No
    After number EQPs: Yes
      n = 1
    comb.termination conditions: No
  Evaluation
    Procedure: Standard
    Potential 1: No
    Potential 3: No
    Stop for reevaluation: No
```

The acid value can be measured using the method conforming to JIS K0070-1992 (Test methods for acid value, saponification value, ester value, iodine value, hydroxyl value and unsaponifiable matter of chemical products) format.

Specifically, first, 0.5 g of the sample (0.3 g for the ethyl acetate-soluble fraction) is dissolved in 120 mL of toluene by stirring at 23 degrees C. for approximately 10 hours. Next, 30 mL of ethanol is added to create the sample solution. If the sample does not dissolve, solvents such as dioxane or tetrahydrofuran are used. Furthermore, using the DL-53 Titrator, automatic potential difference titration device (available from Mettler Toledo International Inc.) and the DG113-SC electrode (available from Mettler Toledo International Inc.), the acid value is measured at 23 degrees C., followed by analyzing using the LabX Light Version 1.00.000 software. For calibration of the equipment, a mixed solvent of 120 mL of toluene and 30 mL of ethanol is used.

The measuring conditions are the same as those for the hydroxyl value.

The acid value can be measured as described above, specifically by titration with a pre-standardized 0.1N potassium hydroxide/alcohol solution. From the volume of titrant used, the acid value [mgKOH/g] is calculated using the formula: Acid value [mgKOH/g]=Titration volume [mL]×N×56.1 [mg/mL]/Sample mass [g] (where N is the factor of the 0.1N potassium hydroxide/alcohol solution).

### Method of Measuring Melting Point and Glass Transition Temperature Tg

The melting point and the glass transition temperature Tg of the toner of the present disclosure can be measured, for example, with a device such as differential scanning calorimetry (DSC) system, DSC-60, available from Shimadzu Corporation.

The melting point and the glass transition temperature of a target sample are measured in the following manner.

About 5.0 mg of a target sample is put in an aluminum sample container, which is placed on a holder unit. The unit and the container are then disposed in an electric furnace. Thereafter, in the nitrogen atmosphere, the unit and the container are heated from 0 to 150 degrees C. at a temperature rising speed of 10 degrees C./min. Then the system is cooled down from 150 to 0 degrees C. at a temperature descending speed of 10 degrees C./min. and again heated to 150 degrees C. at a temperature rising speed of 10 degrees C./min to measure a DSC curve using a difference scanning meter (DSC-60, available from Shimadzu Corporation.

Based on the DSC curve at the first temperature rising cycle selected from the obtained DSC curves using the analysis program “endothermic shoulder temperature” installed in the DSC-60 system, the glass transition temperature at the first temperature rising cycle of the target sample is obtained. The DSC curve at the second temperature rising cycle is selected using the analysis program “endothermic shoulder temperature” to obtain the glass transition temperature of the target sample at the second temperature rising.

Based on the DSC curve at the first temperature rising selected from the obtained DSC curves using the analysis program “endothermic peak temperature” installed in the DSC-60 system, the melting point of the first temperature rising cycle of the target sample is obtained. The DSC curve in the second temperature rising cycle is selected using the analysis program “endothermic peak temperature” to obtain the glass transition temperature of the target sample in the second temperature rising cycle.

In the present specification, the glass transition temperature of a resin particle of the target sample in the first temperature rising cycle is referred to as Tg1st and that in the second temperature rising cycle, Tg2nd.

In the present disclosure, the melting point and Tg in the second temperature rising cycle of each constitutive component are determined as the melting point and Tg of each sample target.

### Method of Measuring Particle Size Distribution

The volume average diameter D4 and the number average diameter Dn of the toner particles, along with their ratio (D4/Dn), can be measured using instruments such as Coulter Counter TA-II and Coulter Multisizer II (both available from Beckman Coulter, Inc.). In the present disclosure, Coulter Multisizer II is utilized for measuring. The measuring method is as follows.

First, 0.1 to 5 mL of a surfactant (preferably polyoxy ethylene alkyl ether (nonionic surfactant) is added as a dispersant to 100 to 150 mL of an electrolytic aqueous solution. The electrolytic aqueous solution is NaCl aqueous solution at approximately 1 percent prepared by using primary NaCl. For example, ISOTON-II (available from Beckman Coulter, Inc.) can be used. Next, 2 to 20 mg of a measuring sample is added. The electrolytic aqueous solution in which the sample is suspended is subjected to dispersion treatment with an ultrasonic wave dispersing device for about one to about three minutes and the volume and the number of toner particles or toner are measured with the measuring device mentioned above with an aperture of 100 μm to calculate the volume distribution and the number distribution. The volume average particle diameter D4 and the number average particle diameter Dn of the toner can be obtained based on the obtained distributions.

The whole range is a particle diameter of from 2.00 to not greater than 40.30 μm and the number of the channels is 13. Each of the channels is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

### Other Optional Components

The other optional components are not particularly limited and can be suitably selected to suit to a particular application. Examples include, but are not limited to, magnetic materials, cleaning improvers, flow improvers, and charge control agents.

### Flow Improver

There is no particular limitation to the flow improver mentioned above and it can be suitably selected to suit to a particular application as long as it is surface-treated for enhancing hydrophobicity and can keep the fluidity and chargeability even in a highly humid environment. Specific examples include, but are not limited to, silane coupling agents, silylating agents, silane coupling agents including an alkyl fluoride group, organic titanate coupling agents, aluminum-containing coupling agents, silicone oil, and modified silicone oil. Hydrophobic silica and hydrophobic titanium oxide, which are formed by surface-treating the silica and the titanium oxide mentioned above with such a flow improver are particularly preferable.

### Cleaning Improver

The cleaning improver is not particularly limited and can be suitably selected to suit to a particular application as long as it is added to the toner in a developing agent to remove the developing agent remaining on an image bearer or a primary intermediate transfer medium after transfer of an image.

Specific examples include, but are not limited to, zinc stearate, calcium stearate, and aliphatic metal salts of stearic acid, polymer fine particles such as polymethyl methacrylate fine particles and polystyrene fine particles, which are prepared by a soap-free emulsion polymerization method. The polymer fine particles preferably have a relatively narrow particle size distribution and the volume average particle diameter thereof is preferably from 0.01 to 1 μm.

### Magnetic Material

The magnetic material is not particularly limited and can be suitably selected to suit to a particular application.

Specific examples include, but are not limited to iron powder, magnetite, and ferrite. Of these, white materials are preferable in terms of color tone.

### Method of Manufacturing Toner

There are no specific restrictions on the manufacturing method of the toner; it can be suitably selected to suit to a particular application. However, it is preferable for the toner to be granulated by dispersing an oil phase containing at least the amorphous polyester resin, crystalline polyester resin, release agent, and colorant in an aqueous medium.

One example of such a toner manufacturing method is the well-known solvent dispersion method.

Another example of the method of manufacturing the toner involves forming mother toner particles while producing a compound (hereinafter referred to as an “adhesive base material) through elongation reaction and/or cross-linking reaction between the compound containing an active hydrogen group and a polymer containing a site reactive with the compound with an active hydrogen group. Such methods involve preparing an aqueous medium, preparing an oil phase containing toner materials, emulsifying or dispersing toner materials, and removing organic solvents.

### Preparation of Aqueous Medium (Aqueous Phase)

The aqueous medium is prepared by, for example, dispersing resin particles in an aqueous medium. There is no specific limitation to the amount of the resin particle added to an aqueous medium. The amount added is suitably selected to suit to a particular application. For example, it is preferably from 0.5 to 10 percent by mass. There is no specific limitation to the resin particle and it can be suitably selected to suit to a particular application. Specific examples include, but are not limited to, surfactants, inorganic compound dispersing agents sparingly soluble in water, and polymeric protective colloids. These can be used alone or in combination. Of these, surfactants are preferable.

The aqueous medium is not particularly limited and can be suitably selected to suit to a particular application. It includes, for example, water, a solvent miscible with water, and a mixture thereof. These can be used alone or in combination. Of these, water is particularly preferable.

The solvent miscible with water is not particularly limited and can be suitably selected to suit to a particular application. It includes, for example, alcohol, dimethyl formamide, tetrahydrofuran, cellosolves, and lower ketones. Alcohol is not particularly limited and can be suitably selected to suit to a particular application. It includes, for example, methanol, isopropanol, and ethylene glycol. Lower ketones are not particularly limited and can be suitably selected to suit to a particular application. It includes, for example, acetone and methylethyl ketone.

### Preparation of Oil Phase

The preparation of an oil phase containing the toner materials can be carried out by dissolving or dispersing toner materials containing the compound containing active hydrogen groups, polymer containing sites reactive with the compound containing active hydrogen groups, a crystalline polyester resin, an amorphous polyester resin, a release agent, a hybrid resin, a colorant, and the like in an organic solvent.

The organic solvent is not particularly limited and can be suitably selected to suit to a particular application. An organic solvent with a boiling point of 150 or lower degrees C. is preferable because it is easy to remove.

There is no specific limitation to the selection of the organic solvents with a boiling point of 150 or lower degrees C. and can be suitably selected to suit to a particular application. Specific examples include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These can be used alone or in combination.

Of these, ethyl acetate, toluene, xylene, benzene, methylene chloride, 1,2-dichloroethane, chloroform, and carbon tetrachloride are preferable and ethyl acetate is particularly preferable.

### Emulsion or Dispersion

The toner material can be emulsified or dispersed by dispersing an oil phase containing the toner material in an aqueous medium. During the emulsification or dispersion of the toner materials, the adhesive base material is generated by subjecting a compound containing active hydrogen groups and a polymer containing sites reactive with the compound containing active hydrogen groups to elongation and/or cross-linking reactions.

The adhesive base material can be prepared by, for example, conducting elongation reaction and/or cross-linking reaction by emulsifying and/or dispersing an oil phase containing a polymer reactive with an active hydrogen group of a polyester prepolymer having an isocyanate group, etc. and a compound having an active hydrogen group such as amines in an aqueous medium; preliminarily emulsifying and/or dispersing an oil phase containing a toner material in an aqueous medium to which a compound having an active hydrogen is added followed by elongation reaction and/or cross-linking reaction of both; or emulsifying and/or dispersing an oil phase containing a toner material in an aqueous medium and then adding a compound having an active hydrogen group to conduct elongation reaction and/or cross-linking reaction of both from the particle interface. When the elongation reaction and/or the cross-linking reaction is conducted in an aqueous medium from the particle interface, a urea-modified polyester resin is preferentially formed on the surface of a toner particle, generating the gradient of the concentration of the urea-modified polyester resin in the thickness direction of the toner particle.

The reaction condition, including reaction time and reaction temperature, of forming an adhesive base material is not particularly limited and can be suitably selected depending on the combination of the compound containing active hydrogen groups and the polymer having a site reactive with the compound containing active hydrogen groups.

The reaction time has no particular limit and can be suitably selected to suit to a particular application. For example, it is preferably from 10 minutes to 40 hours and more preferable from 2 to 24 hours.

There is no specific limit to the reaction temperature. The reaction temperature is preferably from 0 to 150 degrees C. and more preferably from 40 to 98 degrees C.

The method of stably forming a liquid dispersion containing a polymer having a site reactive with a compound having an active hydrogen group in an aqueous medium is not particularly limited and can be suitably selected to suit to a particular application.

A specific method is to add a polymer an oil phase prepared by dissolving or dispersing toner materials in a solvent to an aqueous medium, followed by dispersion by shearing.

There are no specific restrictions on the disperser for the dispersion and it can be suitably selected to suit to a particular application. Examples include, but are not limited to, a low-speed shear disperser, high-speed shear disperser, frictional dispersers, high-pressure jet disperser, and ultrasonic disperser.

Of these, a high speed shearing type dispersion device is preferable because it can control the particle diameter of the dispersion, i.e., oil droplet, in the range of from 2 to 20 μm.

When the high speed shearing type dispersion device is used, conditions such as the rate of rotation, the dispersion time, and the dispersion temperature are suitably selected to suit to a particular application.

The rate of rotation is not particularly limited and can be suitably selected to suit to a particular application. It is preferably from 1,000 to 30,000 rotation per minute (rpm) and more preferably from 5,000 to 20,000 rpm.

There is no specific limit to the dispersion time and is not particularly limited. The dispersion time is preferably from 0.1 to 5 minutes in the batch method.

There is no specific limit to the dispersion temperature and it can be suitably selected to suit to a particular application. The dispersion temperature is preferably from 0 to 150 degrees C. and more preferably from 40 to 98 degrees C. Generally, dispersion is easier at higher temperatures.

The content of the aqueous medium in emulsifying or dispersing the toner material is not particularly limited and can be suitably selected to suit to a particular application. Its number of parts to 100 parts by mass of toner materials is preferably from 50 to 2,000 parts by mass and more preferably from 100 to 1,000 parts by mass.

When the content of the aqueous medium is 50 parts by mass or more, the toner materials disperse well, enabling the production of mother toner particles with a specified particle size. Using 2,000 or less parts by mass reduces production costs.

In the process of emulsifying and/or dispersing an oil phase containing a toner material, a dispersing agent is preferably used to stabilize the dispersion of oil droplets, and make them have a desired form with a sharp particle size distribution.

There is no specific limitation to the dispersion agent and any known dispersion agent can be suitably used. Specific examples include surfactants, inorganic compound dispersion agents sparingly soluble in water, and polymeric protective colloids. These can be used alone or in combination. Of these, surfactants are preferable.

The surfactant mentioned above has no particular limitation and can be suitably selected to suit to a particular application. For example, anionic surfactants, nonionic surfactants, cationic surfactants, and amphoteric surfactants are usable.

The anionic surfactant is not particularly limited and can be suitably selected to suit to a particular application. Specific examples include, but are not limited to, alkylbenzene sulfonates, α-olefin sulfonates, and phosphate esters.

Of these, compounds having a fluoroalkyl group are preferable.

Catalysts can be used for elongation reaction and/or cross-linking reaction during generation of the adhesive base material.

There is no specific limitation to the catalyst and it can be suitably selected to suit to a particular application. Specific examples include, but are not limited to, dibutyl tin laurate and dioctyl tin laurate.

### Removal of Organic Solvent

The method of removing the organic solvent from a liquid dispersion such as the emulsified slurry is not particularly limited and can be suitably selected to suit to a particular application. It includes, for example, a method of evaporating the organic solvent in oil droplets by gradually heating the entire reaction system and a method of spraying a liquid dispersion in dried atmosphere to remove the organic solvent in oil droplets.

When the organic solvent is removed, mother toner particles are formed. The mother toner particles can be subjected to rinsing and drying, along with classification. For example, the mother toner particles can be classified by removing fine particles by a device such as a cyclone, a decanter, and a centrifugal or dried mother toner particles can be classified.

The thus obtained mother toner particles are optionally mixed with particles such as the external additive and charge control agent mentioned above. In this case, applying a mechanical impact force can help to reduce the detachment of particles such as the external additives from the surface of the mother toner particles.

The method of applying a mechanical impact force is not particularly limited and can be suitably selected to suit to a particular application.

Specific examples include, but are not limited to, methods in which an impact is applied to a mixture by using a rapidly rotating blade, introducing the mixture into high-speed airflow to accelerate particles and cause them to collide with each other or with a suitable collision plate.

The device for applying a mechanical impact force used in the method is not particularly limited and can be suitably selected to suit to a particular application.

Specific examples include, but are not limited to, ONG MILL (available from Hosokawa Micron Corporation), modified I TYPE MILL (available from Nippon Pneumatic Mfg. Co., Ltd.) in which the pressure of pulverization air is reduced, HYBRIDIZATION SYSTEM (available from Nara Machine Co., Ltd.), KRYPTRON SYSTEM (available from Kawasaki Heavy Industries, Ltd.), and an automatic mortars.

The liberation ratio of external additives from the toner is directly proportional to the total amount of external additives contained in the toner. However, the surface properties of mother toner particles, such as surface irregularities, dimple shapes, hardness, the presence of particles inhibiting external additive embedding, also significantly has an impact on this ratio. Moreover, the impact force during the mixing of external additives into mother toner particles also leads to considerable variations. Hence, the factors of the total content of liberatable external additive, the characteristics of mother toner particles, and the impact force during external additive mixing intricately intertwine to determine the liberation ratio.

Specifically, a higher content of external additives results in increased amounts of external additives that do not directly contact but are floating from the mother toner particle surface, leading to a higher liberation ratio. Conversely, reducing the external additive content can decrease the liberation ratio until the coating ratio on the mother toner particle surface saturates.

Moreover, concerning the surface properties of mother toner particles, irregular or dimple-shaped mother toner particles have an increased surface area. Consequently, the coverage of external additives also increases, resulting in a lower liberation ratio. When resin fine particles present on the surface of a mother toner particle, they play a role in protecting the surface of the mother toner particle. These resin fine particles act as inhibitors to attachment of external additives, preventing direct embedding of the external additives onto the mother toner particle surface. As a result, the liberation ratio is likely to be high in general. Therefore, the more irregularities present on the surface of a mother toner particle, the fewer particles are present, inhibiting attachment of external additives, leading to a lower liberation ratio. Conversely, the more spherical the shape of the mother toner particle, the greater the presence of particles that inhibit attachment of external additives, resulting in a higher liberation ratio.

Concerning the impact force during external additive mixing, it is generally considered that the total energy applied to the mother toner particle is proportional to the extent of external additive embedding. The variation in total energy can be controlled by adjusting agitation time and peripheral speed. When comparing toners with the same additive content, the toners subjected to lower total energy during mixing tend to have higher liberation ratios, while those subjected to higher total energy tend to have lower liberation ratios.

By applying an optimal mixing energy to the mother toner particle with appropriate average circularity and well-arranged organic resin fine particles, the toner of the present disclosure can demonstrate a stable liberation ratio irrespective of the hazard size within the system.

### Developing Agent

The developing agent of the present disclosure contains at least the toner of the present disclosure and other suitably selected optional components such as carrier.

Therefore, quality images can be produced with the developing agent with excellent transferability and chargeability. The developing agent may be a single-component developing agent or two-component developing agent. However, for a high-speed printer or other devices that support the recent increase in information processing speed, a two-component developing agent is preferable due to its longer lifespan.

When a single-component developing agent is used as the developing agent, there is minimal variation in toner particle size even during toner replenishment. This minimal variation results in minimal toner filming on the developing roller and reduced toner adhesion to components such as the blade for toner layering, and consistent, stable development and image quality during long-term agitation in the developing device.

When a two-component developing agent is used as the developing agent, even over prolonged toner replenishment periods, there is minimal variation in toner particle size, ensuring consistent and stable development and image quality during long-term agitation in the developing device.

For utilizing the toner in a two-component developing agent, it can be mixed with the carrier mentioned above. The carrier content in the two-component developer is not particularly limited and can be suitably selected to suit to a particular application. However, a range between 90 to 98 percent by mass is preferable, with 93 to 97 percent by mass being even more preferable.

### Carrier

There is no specific limitation to the carrier and it can be suitably selected to suit to a particular application. The carrier preferably contains a core material and a resin layer covering the core material.

### Core Material

The feedstock of the core material is not particularly limited and can be suitably selected to suit to a particular application.

Specific examples include, but are not limited to, a manganese-strontium-based material of from 50 to 90 emu/g and a manganese-magnesium-based material of from 50 to 90 emu/g. To achieve a suitable image density, using a high magnetized material such as powdered iron not less than 100 emu/g and magnetite from 75 to 120 emu/g is preferable. Low magnetized materials such as copper-zinc based material having 30 to 80 emu/g are preferable because it can reduce an impact of the developing agent in a filament state on a photoconductor and is advantageous to enhance the image quality.

These can be used alone or in combination.

The volume average particle diameter of the core material is not particularly limited and can be suitably selected to suit to a particular application. For example, the core material preferably has a volume average particle diameter of from 10 to 150 μm and more preferably from 40 to 100 μm. A volume average particle size of 10 or greater μm results in increased fine particles within the carrier, reducing the magnetization per particle and reducing the occurrence of scattering of the carrier, while if the volume average particle size is at or below 150 μm, the specific surface area does not decrease, minimizing toner scattering, thereby ensuring better reproduction of solid areas, especially in solid full color regions.

### Resin Layer

The materials for the resin layer is not particularly limited and can be suitably selected among known resins. Examples include, but are not limited to, amino resins, polyvinyl resins, polystyrene resins, polyhalogenated olefin, polyester resins, polycarbonate resins, polyethylene, polyfluoro vinyl, polyfluoro vinylidene, polytrifluoroethylene, polyhexafluoropropylene, a copolymer of polyfluoro vinylidene and an acryl monomer, a copolymer of polyfluoro vinyl and polyfluoro vinylidene, fluoroterpolymers such as a copolymer of tetrafluoroethylene, fluorovinylidene and a monomer including no fluorine atom, and silicone resins.

These can be used alone or in combination.

The amino resin is not particularly limited and can be suitably selected to suit to a particular application. Specific examples include, but are not limited to, urea-formaldehyde resins, melamine resins, benzoguanamine resins, urea resins, polyamide resins, and epoxy resins.

The polyvinyl resin is not particularly limited and can be suitably selected to suit to a particular application. Specific examples include, but are not limited to, acrylic resins, polymethyl methacrylate resins, polyacrylonitrile resins, polyvinyl acetate resins, polyvinyl alcohol resins, and polyvinyl butyral resins.

The polystyrene resin is not particularly limited and can be suitably selected to suit to a particular application.

Specific examples include, but are not limited to, polystyrene and a styrene-acrylic copolymer.

The polyhalogenated olefin is not particularly limited and can be suitably selected to suit to a particular application. An example is polyvinyl chloride.

The polyester resin is not particularly limited and can be suitably selected to suit to a particular application. Specific examples include, but are not limited to, polyethylene terephthalate and polybutylene terephthalate.

The resin layer optionally contains electroconductive powder. The electroconductive powder is not particularly limited and can be suitably selected to suit to a particular application. Specific examples include, but are not limited to, powdered metal, carbon black, titanium oxide, tin oxide, and zinc oxide. The average particle diameter of such electroconductive powder is preferably 1 or less μm. If the average particle size is 1 or less μm, it is easier to control electric resistance.

The resin layer described above can be formed by dissolving a substance such as a silicone resin in a solvent to prepare a liquid application and applying the liquid application to the surface of the core material described above by a known application method followed by drying and baking.

The application method is not particularly limited and can be suitably selected to suit to a particular application. Specific examples include, but are not limited to, dip coating, spraying, applying with a brush.

The solvent is not particularly limited and can be suitably selected to suit to a particular application. Specific examples include, but are not limited to, toluene, xylene, methylethyl ketone, methylisobutyl ketone, and butylcellosolve acetate.

An external or internal heating system can be used for this baking. For example, a fixed electric furnace, a fluid electric furnace, a rotary electric furnace, a method of using a burner furnace, and a method of using a microwave can be suitably used.

The content of the resin layer in a carrier is not particularly limited and can be suitably selected to suit to a particular application. The content is preferably 0.01 to 5.0 percent by mass. If the content is 0.01 or more percent by mass, it is possible to form a uniform resin layer on the surface of the core material, and if it is 5.0 or less percent by mass, the resin layer does not become too thick, thus reducing the likelihood of fusion between carriers and improving the uniformity of the carriers.

### Toner Accommodating Unit

The toner accommodating unit of the present disclosure includes a unit for accommodating toner and the toner of the present disclosure in the unit. Examples of the toner accommodating unit include, but are not limited to, a toner accommodating container, a developing unit, and a process cartridge.

The toner accommodating container is a vessel containing a toner.

The developing unit has a device for accommodating toner and developing with the toner.

The toner accommodating container is a vessel containing a toner.

The toner accommodating container may be also referred to as a developing agent accommodating container if the toner is used as a developing agent.

The developing agent accommodating container is not particularly limited and can be suitably selected from known containers. One of them is a container with a cap.

The size, structure, and materials of the vessel of the toner accommodating unit and the developing agent accommodating unit are particularly limited.

The shape of the vessel of the developing agent container is not particularly limited and can be suitably selected to suit to a particular application. Preferably, it is a cylinder with irregularities spirally formed on its inner surface. The developing agent, as a content in a vessel, quickly moves towards the vessel's exit following the rotation of the vessel. Preferably, all or part of the irregularities form a bellow-like shape. Due to such a bellow-like structure, the developing agent moves towards the exit more quickly.

The materials of the toner accommodating container and the developing agent accommodating container are not particularly limited, and they can be suitably selected to suit to a particular application. It is preferably a resin such as a polyester resin, a polyethylene resin, a polypropylene resin, a polystyrene resin, a polyvinyl chloride resin, a polyacrylic acid, a polycarbonate resin component, an ABS resin, or a polyacetal resin to demonstrate a good dimensional accuracy.

The toner accommodating container and the developing agent accommodating container are easily stored and conveyed. They can be detachably attached to a process cartridge and an image forming apparatus, which are described later, replenishing the toner or the developing agent in the accommodating unit.

The developing unit has a device for accommodating toner and developing with the toner.

The process cartridge integrally includes at least a latent electrostatic image bearer (also referred to as an image bearer) and a developing device, accommodates toner, and is detachably attachable to an image forming apparatus. The process cartridge may further include at least one member selected from the group consisting of a charger, an exposure (quencher, discharger), and a cleaning device.

### Process Cartridge

The process cartridge relating to the present disclosure is made to be detachably attachable to an image forming apparatus. It includes at least a latent electrostatic image bearer (photoconductor) that bears a latent electrostatic image and a developing device that renders the latent electrostatic image on the latent electrostatic image bearer visible with a developing agent containing the toner of the present disclosure to form a toner image. The process cartridge related to the present disclosure furthermore includes other optional devices.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

The toner accommodating unit, when mounted onto an image forming apparatus for image formation, utilizes the toner's attributes like resistance to offsetting, stable charging, stress endurance, and resistance to background fouling to deliver high-definition, high-quality images consistently over an extended duration. This unit thus enables long-term image stability while forming high-quality, high-definition images.

### Image Forming Apparatus and Image Forming Method

The image forming apparatus of the present disclosure includes a latent electrostatic image bearer, a latent electrostatic image forming device, a development device using the toner of the present disclosure, and other optional devices.

The image forming method of the present disclosure includes forming a latent electrostatic image, developing the latent electrostatic image, and other optional processes. The image forming method can be suitably conducted by the image forming apparatus. The latent electrostatic image can be suitably formed with the latent electrostatic image forming device. The latent electrostatic image can be suitably developed with the developing device. The other optional processes can be suitably conducted by the corresponding other optional devices.

The image forming apparatus more preferably includes a latent electrostatic image bearer, a latent electrostatic image forming device to form a latent electrostatic image on the latent electrostatic image bearer, a developing device to develop the latent electrostatic image on the latent electrostatic image bearer with the toner of the present disclosure to form a toner image, a transfer device to transfer the toner image onto the surface of a recording medium, and a fixing device to fix the toner image on the surface of the recording medium.

The image forming method more preferably includes forming a latent electrostatic image on a latent electrostatic image bearer, developing the latent electrostatic image formed on the latent electrostatic image bearer with the toner of the present disclosure to form a toner image, transferring the toner image formed on the latent electrostatic image bearer to the surface of a recording medium, and fixing the toner image transferred to the surface of the recording medium.

The toner mentioned above is used in the developing device. It is preferable to form the toner image using a developer containing the toner and optional other components such as carrier.

### Latent Electrostatic Image Bearer

There is no specific limitation to the material, the structure, and the size of the latent electrostatic image bearer, also referred to as a photoconductor. The photoconductor can be suitably selected from any known photoconductors. For example, an inorganic photoconductor formed of amorphous silicon or selenium or an organic photoconductor formed of polysilane or phthalopolymethine is suitably used. Of these, amorphous silicon is preferable in terms of long working life.

As an amorphous photoconductor, a photoconductor having a a-Si photoconductive layer can be used which is formed by heating a substrate at 50 to 400 degrees C. followed by film-forming utilizing a film-forming method such as a vacuum deposition method, a sputtering method, an ion-plating method, a thermal chemical vapor deposition (CVD) method, optical CVD method, and plasm CVD method. Of these, the plasma CVD method is preferable in which a material gas is decomposed by a direct current, high-frequency, or a microwave glow discharging to form an accumulated film of a-Si on a substrate.

The latent electrostatic image bearer is not particularly limited and can be suitably selected to suit to a particular application. A latent electrostatic image bearer having a cylindrical form is preferable. The outer diameter of a cylindrical photoconductor is not particularly limited and can be suitably selected to suit to a particular application. It is preferably from 3 to 100 mm, more preferably from 5 to 50 mm, and furthermore preferably from 10 to 30 mm.

### Latent Image Forming Device and Latent Electrostatic Process

The latent electrostatic image forming device in the image forming apparatus of the present disclosure has no particular limitation as long as it can form a latent electrostatic image on a latent electrostatic image bearer and can be suitably selected to suit to a particular application. For example, a device including a charger for charging the surface of a latent electrostatic image bearer and an irradiator for irradiating the surface of the latent electrostatic image bearer imagewise is suitable.

Latent electrostatic images are formed on the latent electrostatic image bearer in the latent electrostatic image forming in the image forming method of the present disclosure. The latent electrostatic image forming includes charging the surface of the latent electrostatic image bearer and irradiating the charged surface with beams of light to form a latent electrostatic image.

Charging is conducted by applying a bias to the latent electrostatic image bearer's surface with a charger, for example.

This irradiation is conducted by irradiating the surface of the latent electrostatic image bearer with an irradiator according to image information.

Latent electrostatic images can be formed, for instance, by uniformly charging the surface of a latent electrostatic image bearer and subsequently exposing it to image-like irradiation based on the acquired image information, accomplished through a latent electrostatic image forming device.

### Charging Device (Charger)

The charger is not particularly limited and can be suitably selected to suit to a particular application.

Specific examples include, but are not limited to, a contact type charger such as an electroconductive or semiconductive roll, brush, film, or a rubber blade, and a non-contact type charger utilizing corona discharging such as corotron or scorotron.

The charger may employ a roller form and any other form such as a magnetic brush and a fur brush, and can be selected according to the specification or form of an image forming apparatus.

Preferably, the charger is disposed in contact or non-contact with the latent electrostatic image bearer and applies a direct voltage and an alternating voltage superimposed thereon to the surface of the latent electrostatic image bearer. The charger is preferably a charging roller disposed in contact with the latent electrostatic image bearer with a gap tape therebetween. It is also preferable that the charging roller apply a direct voltage on which an alternate voltage is superimposed to charge the surface of the latent electrostatic image bearer.

The charger is not particularly limited to the contact type charging device but is preferable because such a charger contributes to manufacturing an image forming apparatus producing less amount of ozone.

### Irradiating Device (Irradiator)

The irradiator is not particularly limited and can be suitably selected to suit to a particular application as long as it can irradiate the surface of a latent electrostatic image bearer charged with a charger according to image information.

Specific examples of such irradiators include, but are not limited to, a photocopying optical system, a rod lens array system, a laser optical system, and a liquid crystal shutter optical system.

The light source for the irradiator has no particular limitation and can be suitably selected to suit to a particular application. Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used to irradiate a latent electrostatic image bearer with beams of light having only a desired wavelength.

It includes, but is not limited to, a sharp cut filter, a band-pass filter, a near infrared filter, a dichroic filter, a coherent filter, and a color conversion filter.

The rear side irradiation system, which irradiates a latent electrostatic image bearing member from its rear side, can be also employed.

### Developing Device and Developing Process

The developing device in the image forming apparatus of the present disclosure is not particular limited and can be suitably selected to suit to a particular application as long as it can contain a toner for developing a latent electrostatic image formed on a latent electrostatic image bearer to form a visible image.

In the developing process in the image forming method of the present disclosure, a toner image is formed by sequentially developing a latent electrostatic image with multiple color toners. The toner image is formed by, for example, developing the latent electrostatic image with the toner using the developing unit.

The developing device and the developing process use the toner according to an embodiment of the present invention. It is preferable to form toner images with a developing agent containing the toner according to an embodiment of the present invention and other optional components such as a carrier.

In addition, the developing unit may be a single color or multi-color developing device. Preferably, the developing unit includes a stirrer for triboelectrically charging toner, a magnetic field generator fixed inside, and a rotatable developing agent bearer that bears a developing agent on its surface.

In the developing unit, for example, the toner and the carrier are mixed and agitated to charge the toner due to the friction therebetween. The toner is held on the surface of the rotating magnet roller, forming a magnet brush like a filament. Since the magnet roller is provided near the latent electrostatic image bearer (photoconductor), some toner forming the magnet brush on the magnet roller's surface is electrically attracted to the surface of the latent electrostatic image bearer. As a result, the latent electrostatic image is developed with the toner and rendered visible with the toner on the surface of the latent electrostatic image bearer.

The image forming apparatus of the present disclosure can include four developing device for color toner (black, cyan, magenta, and yellow), and another developing device for the toner of the present disclosure. The toner of the present disclosure may adopt any color, preferably colorless or white. The toner according to an embodiment of the present invention can be all or a part of the color toners of black, cyan, magenta, and yellow used in the developing device.

### Cleaner and Cleaning Process

The image forming apparatus of the present disclosure preferably include a cleaning device (cleaner).

As described above, the toner of the present disclosure excels in cleaning performance. When the toner is applied to the image forming apparatus with a cleaner, the cleaning performance is enhanced in the following points.
By enhancing the spacer effect of the mother toner particle, the flowability of the toner is maintained even under stress, leading to improved cleaning properties.
Additionally, ensuring that the amount B (percent by mass) of the isolated external additives (silica) satisfies the equation 3 above allows for sufficient liberation of the additives from the toner on the photoconductor. This enables the formation of a deposition layer (dam layer) of the external additives in the cleaning blade nip area, thus achieving superior cleaning performance.

There is no specific limitation to the selection of the cleaning device and any known cleaner that can remove the toner remaining on the image bearer is suitably used. Specific examples of such cleaners include, but are not limited to, a magnetic brush cleaner, an electrostatic brush cleaner, a magnetic roller cleaner, a blade cleaner, a brush cleaner, and a web cleaner.

The image forming method of the present disclosure preferably include a cleaning process.

In the cleaning process, the toner remaining on the image bearer is removed with the cleaning device mentioned above.

The image forming apparatus in the present disclosure enhances its cleaning performance through the aforementioned cleaning device.

Specifically, by controlling the adhesion between toner particles, the toner's flowability is regulated, leading to improved cleaning performance. Furthermore, by managing the characteristics of degraded toner, the toner can maintain excellent cleaning properties, ensuring prolonged functionality even in challenging conditions such as high temperature and high moisture environments. Moreover, since the external additive can be sufficiently isolated from the toner on a photoconductor, it can form an accumulating layer, or a dam layer, at the cleaning blade nipping portion, thereby achieving superior cleanliness.

### Other Optional Unit and Other Optional Step

The other processes can be suitably performed by other devices, such as a transfer device, fixing device, discharging device, recycling device, and control device.

### Transfer Device and Transfer Process

The transfer device in the image forming apparatus of the present disclosure preferably includes a primary transfer device for transferring a toner image to an intermediate transfer member to form a complex transfer image and a secondary transfer device for transferring the complex transfer image to a printing medium. The intermediate transfer member is not particularly limited and can be suitably selected from the known transfer members. One of the intermediate transfer bodies is a transfer belt.

In the transfer process carried out by the image forming apparatus of the present disclosure, a toner image is transferred to a recording medium. In the transferring, it is preferable to use an intermediate transfer member. The toner image is primarily transferred to an intermediate transfer member and then secondarily transferred to a printing medium.

More preferably, the transferring includes primarily transferring toner images formed with two or more color toners, preferably full color toners, onto an intermediate transfer member, where each toner image is overlapped to form a complex transfer image and secondarily transferring the complex transfer image to a printing medium,

The toner image is transferred by, for example, charging the latent electrostatic image bearer with a transfer charger, which is carried out by the transfer device.

The transfer device (the primary transfer device and the secondary transfer device mentioned above) preferably includes a transfer unit for peeling-charge the toner image formed on the latent electrostatic image bearer or photoconductor to peel the image to the printing medium. One or more transfer devices can be provided.

Specific examples of the transfer device include, but are not limited to, a corona transfer device using corona discharging, a transfer belt, a transfer belt, a transfer roller, a pressure transfer roller and an adhesive transfer device.

There is no particular limitation to the recording medium, and it can be suitably selected to suit to a particular application as long as an unfixed image is transferred after development. It includes any paper such as plain paper and PET base for an overhead projector.

### Fixing Device and Fixing Process

There is no specific limitation to the fixing device in the image forming apparatus of the present disclosure, and it can be suitably selected to suit to a particular application. Using a known heating and pressing device that applies heating and pressure is preferable. The heating and pressing device includes, but is not limited to, a combination of a heating roller and a pressing roller or a combination of a heating roller, a pressing roller, and an endless belt can be suitably used.

In the fixing process executed by the image forming apparatus of the present disclosure, the toner image transferred onto the printing medium is fixed with a fixing device. Fixing can be conducted every time each color toner image is transferred or after a multi-color overlapped image is transferred once.

For example, a preferable fixing device includes a heating body including a heat-generating member, a film in contact with the heating body, and a pressing member for pressing the heating body via the printing medium to fix an unfixed image on a printing medium while the printing medium passes between the film and the pressing member.

The heating temperature at the pressure and heat applied portion is preferably 80 to 200 degrees C.

The surface pressure at the pressure and heat applied portion is not particularly limited and can be suitably selected to suit to a particular application. Preferably, it is from 10 to 80 N/cm².

In the present embodiment, a device such as an optical fixing device can be used together with or instead of the fixing device.

### Recycling Device and Recycling Process

Any known recycling device can be suitably selected and used as the recycling device.

The recycling process is to return the toner removed in the cleaning process to the developing device for recycling and can be conducted by the recycling device mentioned above.

### Control Device

The control device controls the behaviors of individual devices mentioned above. There is no specific limit to the control device, and any controller can be suitably selected to suit to a particular application as long as it can control the behavior of each device. For example, controlling device such as a sequencer and a computer are preferable.

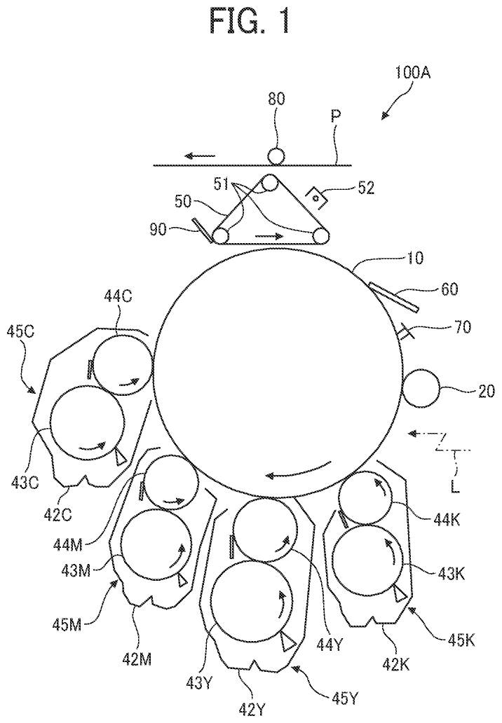

Next, an embodiment of forming images with the image forming apparatus of the present disclosure is described with reference to FIG. 1.

FIG. 1 is a diagram illustrating an example of the image forming apparatus for use in the present disclosure. A color image forming apparatus 100A illustrated in FIG. 1 includes a drum photoconductor 10 (hereinafter, also referred to as photoconductor 10) as the latent electrostatic image bearer, a charging roller 20 as the charging device, an irradiator for irradiating the photoconductor 10 with a beams of light L, a developing unit 40 as the developing device, an intermediate transfer member 50, a cleaner 60 as the cleaning device having a cleaning blade, and a discharging lamp 70 as the discharging device.

The intermediate transfer member 50 is a belt having an endless form and is designed to be movable in the direction indicated by the arrow by three rollers 51 which are disposed inside the intermediate transfer member 50 and stretches the intermediate transfer member 50. The three rollers 51 partially serves as a transfer bias roller to apply a transfer bias (primary transfer bias) to the intermediate transfer member 50. Around the intermediate transfer member 50 is disposed a cleaner 90 including a cleaning blade. Around the intermediate transfer member 50, a transfer roller 80 is disposed as the transfer device capable of applying a transfer bias to transfer (secondary transfer) a developed image (toner image) onto a transfer paper P as a recording medium while facing the intermediate transfer member 50. Around the intermediate transfer member 50, a corona charger 52 to apply charges to the toner image on the intermediate transfer member 50 is disposed between the contact portion of the drum photoconductor 10 and the intermediate transfer member 50 and the contact portion between the intermediate transfer member 50 and the transfer sheet P along the rotation direction of the intermediate transfer member 50.

Around the drum photoconductor 10 are disposed a black developing unit 45K, a yellow developing unit 45Y, a magenta developing unit 45M, and a cyan developing unit 45C facing it. The black developing unit 45K includes a developer accommodating unit 42K, a developer supplying roller 43K, and a developing roller 44K. The yellow developing unit 45Y includes a developer accommodating unit 42Y, a developer supplying roller 43Y, and a developing roller 44Y. The magenta developing unit 45M includes a developing agent accommodating unit 42M, a developing agent supplying roller 43M, and a developing roller 44M. The cyan developing unit 45C includes a developing agent accommodating unit 42C, a developing agent supplying roller 43C, and a developing roller 44C.

The color image forming apparatus 100A illustrated in FIG. 1 uniformly charges the drum photoconductor 10 with the charging roller 20. The toner image is (primarily) transferred onto the intermediate transfer member 50 by a voltage applied with the roller 51 and then (secondarily) transferred to the transfer paper P. As a result, a transfer image is formed on the transfer sheet P. The residual toner on the drum photoconductor 10 is removed by the cleaner 60, and the charge on the drum photoconductor 10 is temporarily discharged by the discharging lamp 70.

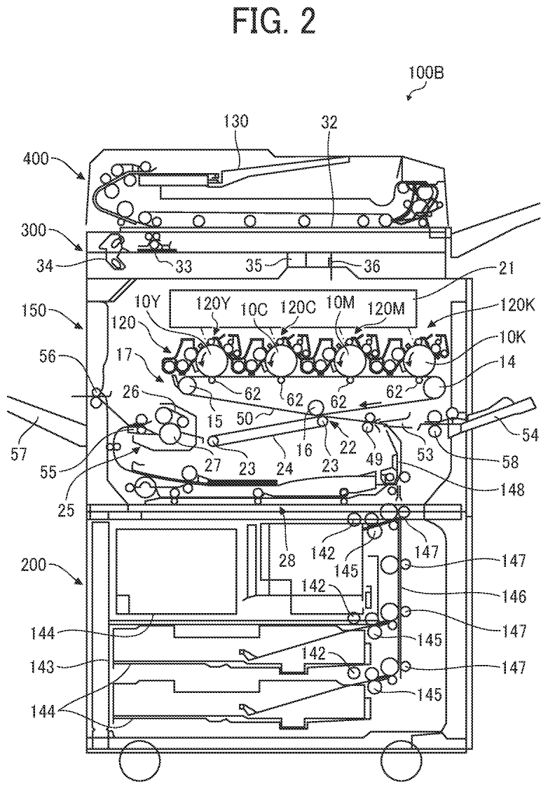

FIG. 2 is a diagram illustrating another example of the image forming apparatus of the present disclosure. The image forming apparatus 100B illustrated in FIG. 2 includes a photocopying unit 150, a sheet feeding table 200, a scanner 300, and an automatic document feeder (ADF) 400.

The photocopying unit 150 of the image forming apparatus has an intermediate transfer member 50 with an endless belt disposed at the center thereof. The intermediate transfer member 50 is stretched over support rollers 14, 15 and 16 and rotatable clockwise in FIG. 2. An intermediate transfer member cleaner 17 is disposed around the support roller 15 to remove residual toner on the intermediate transfer member 50. A tandem developing device 120 has four developing units of yellow, cyan, magenta, and black, an image forming device 120Y, an image forming device 120C, an image forming device 120M, and an image forming device 120K, disposed along the conveyance direction of the intermediate transfer member 50 suspended over the support rollers 14 and 15. Near the tandem developing device 120, an irradiator 21 is arranged. A secondary transfer device 22 is disposed facing the tandem developing device 120 with the intermediate transfer member 50 therebetween. In the secondary transfer device 22, a secondary transfer belt 24 having an endless form is stretched over a pair of rollers 23. A transfer medium transferred onto the secondary transfer belt 24 can be brought into contact with the intermediate transfer member 50. A fixing device 25 as the fixing device is disposed near the secondary transfer device 22. The fixing device 25 includes a fixing belt 26 having an endless form and a pressure roller 27 pressed against the fixing belt 26.

In addition, in the tandem image forming apparatus, a sheet reverse device 28 for forming images on both sides of the transfer medium by reversing the transfer medium is disposed near the secondary transfer device 22 and the fixing device 25.

Next, the formation of a full color image using a tandem developing device is described. First, a document (original) is set on a document table 130 on the automatic document feeder 400 or the automatic document feeder 400 is opened to set a document on a contact glass 32 for the scanner 300, and thereafter the automatic document feeder 400 is closed.

When the start button is pressed, the scanner 300 is driven after the original is transferred onto the contact glass 32 in the case where the original is set on the automatic document feeder 400. On the other hand, the scanner 300 is immediately driven in the case where the original is set on the contact glass 32. Then a first scanning unit 33 and a second scanning unit 34 scan the original. Then the original is irradiated with light from the first scanning unit 33. The reflection light from the original is redirected at the mirror of the second scanning unit 34. The redirected light is received at a reading sensor 36 via an imaging forming lens 35 to read the color original to obtain image data information for black, yellow, magenta, and cyan.

Each image information on black, yellow, magenta, and cyan is conveyed to the image forming device 120K, the image forming device 120Y, the image forming device 120M, and the image forming device 120C, respectively. Each toner image of black, yellow, magenta, and cyan is formed at respective image forming devices.

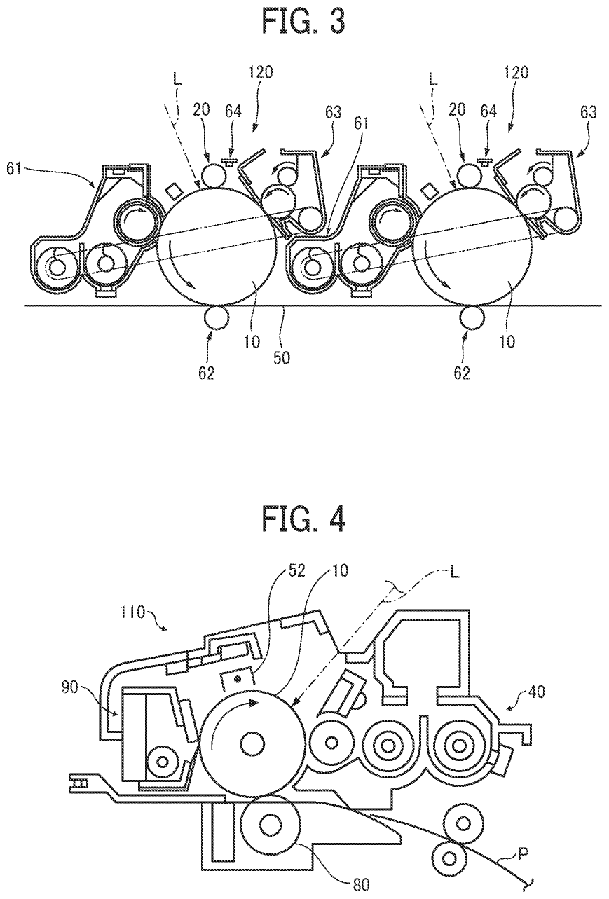

FIG. 3 is a diagram illustrating an example of a part of each image forming device in the tandem developing device. As illustrated in FIG. 3, the tandem developing device 120 includes respective latent electrostatic image bearing members (drum photoconductors) 10 (for example, a latent electrostatic image bearing member 10K for black, a latent electrostatic image bearing member 10Y for yellow, a latent electrostatic image bearing member 10M for magenta, and a latent electrostatic image bearing member 10C for cyan), a charger (charging roller) 20 that uniformly charges the latent electrostatic image bearing members 10, an irradiator that irradiates the latent electrostatic image bearing members 10 with beams of light L according to each color image data to form a latent electrostatic image corresponding to each color image on the latent electrostatic image bearing members 10, a developing unit 61 as the developing device that forms a toner image with each color toner by developing each latent electrostatic image with each color toner (black toner, yellow toner, magenta toner, and cyan toner), a transfer charger 62 that transfers the toner image to the intermediate transfer member 50, a cleaner 63, and a discharging device 64. Each image forming unit 120 can form each corresponding single color image (black image, yellow image, magenta image, and cyan image) based on each color image data. The black image, the yellow image, the magenta image, and the cyan image formed on the latent electrostatic image bearer 10K for black, the latent electrostatic image bearer 10Y for yellow, the latent electrostatic image bearer 10M for magenta, and the latent electrostatic image bearer 10C for cyan, respectively, are primarily transferred sequentially to the intermediate transfer member 50 rotated by the support rollers 14, 15, and 16. Then the black image, the yellow image, the magenta image, and the cyan image are superimposed on the intermediate transfer member 50 to form a synthetic color composite image (color transfer image).

At the sheet feeding table 200, one of feeding rollers 142 is selectively rotated to feed a sheet (printing medium) from one of medium feeding cassettes 144 stacked in a medium bank 143. The printing medium is separated by a separating roller 145 one by one to a medium feeding path 146. The printing medium is guided by conveying rollers 147 to a medium feeding path 148 in the photocopying unit 150 and halted at registration roller 49. Alternatively, a sheet feeding roller 142 is rotated to bring up the printing media (sheets) on a bypass tray 54. The printing media are separated one by one with a separating roller 58, conveyed to a manual sheet path 53, and also halted at the registration roller 49. The registration roller 49 is generally grounded but a bias can be applied thereto to remove paper dust on the printing medium. The registration roller 49 is rotated in synchronization with the overlapped color composite image (color transfer image) on the intermediate transfer member 50 to feed the printing medium (sheet) between the intermediate transfer member 50 and the secondary transfer device 22. The overlapped color composite image is secondarily transferred to the printing medium (sheet). Thus, the color composite image is transferred to and formed on the printing medium. The residual toner remaining on the intermediate transfer member 50 after the image transfer is removed with the intermediate transfer member cleaner 17.

The printing medium (sheet) with transferred color image thereon is conveyed to the secondary transfer device 22 and then sent out to the fixing device 25. The fixing device 25 fixes the overlapped color composite image on the printing medium with heat and pressure. Thereafter, the printing medium is directed at a switching claw 55 to an ejection roller 56, which ejects the printing medium to stack it on an ejection tray 57. Alternatively, the printing medium is switched at the switching claw 55 to the reversing device 28, which guides the printing medium to the transfer position again. Then an image is formed on the other side of the printing medium and ejected to the ejection roller 56 to stack it on the ejection tray 57.

FIG. 4 is a diagram illustrating an example of the process cartridge relating to the present disclosure. The process cartridge 110 includes a drum photoconductor (latent electrostatic image bearer) 10, a corona charger 52, a developing device 40, a transfer roller 80, and a cleaner 90.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. The terms parts and percent respectively refer to parts by mass and percent by mass.

### Manufacturing of Toner

### Manufacturing Example 1

### Synthesis of Crystalline Polyester Resin 1

A reaction vessel, equipped with a nitrogen introducing tube, a dehydration tube, a stirrer, and a thermocouple, was charged with sebacic acid and 1,6-hexanediol. At this point, the molar ratio of hydroxyl to carboxyl was set at 0.9, and 500 ppm of titanium tetraisopropoxide was added to the total monomers. Subsequent to continuing reaction for 10 hours at 180 degrees C., the temperature was raised to 200 degrees C. and maintained for an additional 3 hours of reaction. Further, the reaction was continued for 2 hours under a vacuum of 8.3 kPa, resulting in obtaining Crystalline Polyester Resin 1. Crystalline Polyester Resin 1 exhibited a melting point of 67 degrees C. and a weight-average molecular weight of 25,000.

### Manufacturing Example 2

### Synthesis of Amorphous Polyester Resin 1

In a 5 L four-neck flask equipped with a nitrogen introducing tube, dehydration tube, stirrer, and thermocouple, 1427.5 g of an adduct of bisphenol A with 2 mols of propylene oxide, 20.2 g of trimethylolpropane, 512.7 g of terephthalic acid, and 119.9 g of adipic acid were placed. The mixture was allowed to react at 230 degrees C. under atmospheric pressure for 10 hours, followed by a 5-hour reaction under a reduced pressure ranging from 10 to 15 mmHg. Subsequently, 41.0 g of anhydrous trimellitic acid was introduced into the reaction vessel and allowed to react for 3 hours at 180 degrees C. under atmospheric pressure to obtain Amorphous

### Polyester Resin 1.

Amorphous Polyester Resin 1 exhibited a weight average molecular weight of 10,000, a number-average molecular weight of 2,900, a Tg of 57.5 degrees C., and an acid value of 20 mg KOH/g.

### Manufacturing Example 3

### Synthesis of Prepolymer 1

The following components were placed in a container equipped with a condenser, a stirrer and a nitrogen introducing tube to conduct reaction at 230 degrees C. under atmospheric pressure for 8 hours followed by another reaction for 5 hours with a reduced pressure ranging from 10 mmHg to 15 mmHg to synthesize Intermediate Polyester 1:
Adduct of bisphenol A with 2 mols of ethylene oxide: 682 parts
Adduct of bisphenol A with 2 mols of propylene oxide: 81 parts
Terephthalic acid: 283 parts
Trimellitic anhydride: 22 parts
Dibutyl tin oxide: 2 parts Intermediate Polyester 1 had a number average molecular weight of 2,100, a weight average molecular weight of 9,500, a glass transition temperature Tg of 55 degrees C., an acid value of 0.5 mgKOH/g, and a hydroxyl value of 51 mgKOH/g.

Next, 410 parts of Intermediate Polyester 1, 89 parts of isophorone diisocyanate, and 500 parts of ethyl acetate were placed in a reaction container equipped with a condenser, a stirrer and a nitrogen introducing tube to conduct reaction at 100 degrees C. for 5 hours to obtain Prepolymer 1. The obtained Prepolymer 1 had an isolated isocyanate in an amount of 1.53 percent by mass.

### Manufacturing Example 4

### Synthesis of Ketimine Compound 1

A total of 170 parts of isophoronediamine and 75 parts of methyl ethyl ketone were placed in a reaction container equipped with a stirrer and a thermometer to react at 50 degrees C. for 5 hours to obtain Ketimine Compound 1. Ketimine Compound 1 had an amine value of 418 mgKOH/g.

### Manufacturing Example 5

### Preparation of Master Batch 1

A total of 1,200 parts of water, 540 parts of carbon black (Printex 35, available from Degussa AG, DBP oil absorption amount: 42 ml/100 mg, PH: 9.5), and 1,200 parts of polyester resin were mixed with a Henschel Mixer (available from NIPPON COKE & ENGINEERING. CO., LTD.). The mixture was then kneaded at 150 degrees C. for 30 minutes using two rolls and thereafter rolled and cooled down followed by pulverization with a pulverizer to obtain Master Batch 1.

### Manufacturing Example 6

### Preparation of Liquid Dispersion 1 of Wax

A total of 50 parts of paraffin wax (HNP-9, hydrocarbon wax, melting point of 75 degrees C., SP value of 8.8, available from Nippon Seiro Co., Ltd.) as Release Agent 1 and 450 parts of ethyl acetate were placed in a container equipped with a stirrer and a thermometer. While the mixture was being stirred, the system was heated to 80 degrees C. After maintaining the temperature at 80 degrees C. for five hours, the system was cooled down to 30 degrees C. in an hour. The resulting mixture was subjected to dispersion with a bead mill (ULTRAVISCOMILL, available from AIMEX) under conditions of a liquid transfer speed of 1 kg/hour, a disk peripheral speed of 6 m/s, and a filling ratio of 0.5 mm zirconia beads of 80 percent by volume with three passes to obtain Liquid Dispersion 1 of Wax.

### Manufacturing Example 7

### Preparation of Liquid Dispersion 1 of Crystalline Polyester Resin

In a 2 L metal container, 100 parts of Crystalline Polyester Resin 1 and 200 parts of ethyl acetate were placed and heated to 75 degrees C. for dissolution. Subsequently, the solution was rapidly cooled at a rate of 27 degrees C./minute in an ice-water bath. Then 500 mL of glass beads (3 mm φ) were added, and the mixture was milled using a batch-type sand mill device (available from Company X) for 10 hours to obtain Liquid Dispersion 1 of Crystalline Polyester Resin.

### Manufacturing Example 8

### Manufacturing of Aqueous Liquid Dispersion (W0-1) of Resin Fine Particle A

In a reaction vessel equipped with a stirrer, a heating-cooling device, and a thermometer, 3,710 parts of water and 200 parts of polyoxyethylene-1-(allyloxymethyl) alkyl ether sulfate ammonium (Aquaron KH-1025, available from DKS Co., Ltd.) were charged and stirred at 200 rotations per minute for homogenization. The homogenized mixture was heated until the internal temperature reached 75 degrees C. Subsequently, 90 parts of a 10 percent ammonium persulfate solution were added, and then a liquid mixture of 450 parts of styrene, 250 parts of butyl acrylate, and 300 parts of methacrylic acid was dropwise added over 4 hours.

After dropwise addition, the resulting mixture was aged at 75 degrees C. for 4 hours, yielding an aqueous dispersion (W0-1) containing a copolymer denoted as resin (a1-1) of the monomers and polyoxyethylene-1-(allyloxymethyl) alkyl ether sulfate ammonium.

The volume-average particle diameter of fine particles in the aqueous liquid dispersion (W0-1) was measured using dynamic light scattering (ELS-8000, electrophoretic light scattering apparatus: available from Otsuka Electronics Co., Ltd.), and was found to be 15 nm. A portion of the aqueous liquid dispersion (W0-1) was dried to isolate the resin (a1-1). The glass transition temperature TgA of the isolated resin was 75 degrees C. and the acid value was 195 mgKOH/g.

### Manufacturing Example 9

### Manufacturing of Aqueous Liquid Dispersion (W-1) of Resin Fine Particle B

In a reaction vessel equipped with a stirrer, a heating-cooling device, and a thermometer, the aqueous liquid dispersion (W0-1) of resin fine particle A totaling 667 parts and 248 parts of water were charged. To this mixture, 0.267 parts of tert-butyl hydroperoxide (Parbutyl H, available from NOF CORPORATION) were added, followed by heating until the internal temperature reached 70 degrees C. Subsequently, a mixture of 43.3 parts of styrene, 23.3 parts of butyl acrylate, and 18.0 parts of a 1 percent ascorbic acid solution was dropwise added over 2 hours.

After the dropwise addition, the resulting mixture was allowed to mature at 70 degrees C. for 4 hours. This process yielded aqueous liquid dispersion (W-1) of resin fine particles B containing resin (a2-1), a copolymer of the monomers, formed utilizing resin fine particle A as a seed within the aqueous liquid dispersion (W0-1), along with resin (a1-1) within the same particle.

The volume-average particle size of resin fine particles B was measured similarly and found to be 17.3 nm.

Following neutralizing the aqueous liquid dispersion (W-1) of resin fine particles B with a 10 percent ammonia aqueous solution to reach pH 9.0, the resulting precipitate obtained from centrifugal separation was dried and solidified to isolate resin (a2-1). The glass transition temperature Tg of the isolated resin was 61 degrees C.

The presence of resin fine particles B containing resin (a1-1) and resin (a2-1) as constituent components within the same particle was confirmed as follows:

Specifically, 2 parts of gelatin (Cook Gelatin, available from MORINAGA MILK INDUSTRY CO., LTD.) were dissolved in 15 parts of water heated to 95 to 100 degrees C. After cooling to 40 degrees C., the gelatin aqueous solution obtained was mixed at a 1:1 mass ratio with the aqueous liquid dispersion (W-1) of resin fine particles A-1. The mixture was thoroughly stirred and then solidified by cooling at 10 degrees C. for 1 hour to form a gel.

This gel was used to produce 80 nm-thick sections while temperature-controlled at −80 degrees C. using an ultramicrotome (Ultramicrotome UC7, FC7, available from Leica Microsystems). These sections were stained by a 2 percent ruthenium tetroxide solution in vapor for 5 minutes and observed using a transmission electron microscope (H-7100, available from Hitachi High-Technologies Corporation) to confirm the presence of resin fine particles B containing resin (a1-1) and resin (a2-1) as constituent components within the same particle.

### Manufacturing Example 10

### Manufacturing of Liquid Dispersion 1 of Resin Fine Particle

The following recipe was placed in a container equipped with a stirrer and a thermometer and stirred at 400 rpm for 15 minutes to obtain a white emulsion:
Water: 683 parts
Sodium salt of sulfate of an adduct of methacrylic acid with ethyleneoxide (EREMINOR RS-30, available from Sanyo Chemical Industries, Ltd.): 11 parts
Styrene: 138 parts
Methacrylic acid: 138 parts
Ammonium persulfate: 1 part

The system was heated until the temperature in the system was 75 degrees C. to allow reaction for 5 hours. Furthermore, 30 parts of 1 percent ammonium persulfate aqueous solution followed by aging at 75 degrees C. for 5 hours to obtain an aqueous liquid dispersion of Liquid Dispersion 1 of Resin Fine Particle of a vinyl resin (copolymer of styrene, methacrylic acid, and a sodium salt of an adduct of a sulfate ester of methacrylic acid ethyleneoxide). The volume-average particle diameter of Liquid Dispersion 1 of Resin Fine Particle was measured using the equipment named LA-920, available from HORIBA). It was 0.14 μm. A portion of Liquid Dispersion 1 of Resin Fine Particle was dried to isolate the resin component.

The manufactured products of Manufacturing Examples 1 to 10 are shown in Table 1.

TABLE 1

| Manufacturing | |
|---|---|
| Example No. | Manufactured Matter |
| Manufacturing | Crystalline polyester resin 1 |
| Example 1 | |
| Manufacturing | Amorphous polyester resin 1 |
| Example 2 | |
| Manufacturing | Prepolymer 1 |
| Example 3 | |
| Manufacturing | Ketimine compound 1 |
| Example 4 | |
| Manufacturing | Masterbatch 1 |
| Example 5 | |
| Manufacturing | Liquid dispersion 1 of WAX |
| Example 6 | |
| Manufacturing | Liquid dispersion 1 of crystalline polyester resin |
| Example 7 | |
| Manufacturing | Aqueous liquid dispersion (W0-1) of resin fine |
| Example 8 | particle A |
| Manufacturing | Aqueous liquid dispersion (W-1) of resin fine |
| Example 9 | particle B |
| Manufacturing | Liquid dispersion 1 of resin fine particle |
| Example 10 | |

### Example 1

### Preparation of Toner

### Preparation of Oil Phase 1

Into a container, 500 parts of Liquid Dispersion 1 of Wax, 200 parts of Prepolymer 1, 150 parts of Liquid Dispersion 1 of Crystalline Polyester Resin, 750 parts of Amorphous Polyester Resin 1, 100 parts of Masterbatch 1, 8 parts of Inorganic Filler 1 (trimethyl stearyl ammonium modified montmorillonite), and as a curing agent, 2 parts of Ketimine Compound 1 were placed. The mixture was then mixed in a TK Homomixer (available from Priymix Corporation) at 5,000 rpm for 60 minutes to obtain Oil Phase 1.

### Preparation of Aqueous Phase 1

Into a beaker, 990 parts of deionized water, a mixture of 33 parts of aqueous dispersion (W-1) and 60 parts of aqueous dispersion (W0-1), 6 parts of sodium carboxymethyl cellulose, 37 parts of sodium dodecyl diphenyl ether disulfonate (Elemineol MON-7, available from Sanyo Chemical Industries), and 90 parts of ethyl acetate were added to obtain Aqueous Phase 1.

### Emulsification and Removal of Solvent

Into the container containing Oil Phase 1, 1,200 parts of Aqueous Phase 1 was loaded. The resulting mixture was mixed with a TK HOMOMIXER at 13,000 rpm for 20 minutes to obtain Slurry Emulsion 1.

Slurry Emulsion 1 was introduced into a container fitted with a stirrer and a thermometer, followed by an 8-hour solvent removal process at 30 degrees C. Subsequently, a 4-hour aging period at 45 degrees C. was conducted, resulting in the formation of Slurry Dispersion 1.

### Cleaning, Heat Treatment, and Drying

After reduced pressure filtration of 100 parts of Slurry Dispersion 1,
(I): A total of 100 parts of deionized water was added to the filtered cake, mixed using a TK Homomixer at 12,000 rpm for 10 minutes, and subsequently filtered.
(2): A total of 100 parts of sodium hydroxide at 10 percent was added to the filtered cake obtained in the (1), mixed using a TK Homomixer at 12,000 rpm for 30 minutes, and then reduced-pressure filtered.
(3): A total of 100 parts of hydrochloric acid at 10 percent was added to the filtered cake obtained in the (2), mixed using a TK Homomixer at 12,000 rpm for 10 minutes, and subsequently filtered.
(4): A total of 300 parts of deionized water was added to the filtered cake obtained in the (3), mixed using a TK Homomixer at 12,000 rpm for 10 minutes, and then filtered. The processes, from the (1) to (4), were carried out twice to obtain a filtered cake.
(5): A total of 100 parts of deionized water was added to the filtered cake obtained in the (4), mixed using a TK Homomixer at 12,000 rpm for 10 minutes, heated at 50 degrees C. for 4 hours, and filtered, resulting in formation of Filtered Cake 1.
(6): Filtered Cake 1 was dried in a circulating air dryer at 45 degrees C. for 48 hours and sieved through a 75 μm mesh sieve, resulting in formation of Mother Toner Particle 1.

Using a Henschel Mixer (available from NIPPON COKE & ENGINEERING CO., LTD.), 100 parts of Mother Toner Particle 1 were mixed with 2.4 parts of hydrophobic silica particles with an average particle size of 160 nm and 1.4 parts of colloidal silica with an average particle size of 20 nm (Aeroxil R972, available from Nippon Aerosil Co., Ltd.) under the conditions of peripheral speed at 40 m/s and stirring time of 8 minutes, resulting in Toner 1.

### Example 2

Toner 2 was obtained in the same manner as in Example 1 except that the quantity of hydrophobic silica particles with an average particle size of 160 nm was changed from 2.4 parts to 1.7 parts, and the quantity of colloidal silica with an average particle size of 20 nm (Aeroxil R972, available from Nippon Aerosil Co., Ltd.) was changed from 1.4 parts to 0.8 parts for the external addition treatment.

The evaluation was conducted in the same manner as Example 1, except for the use of Toner 2.

### Example 3

Toner 3 was obtained in the same manner as in Example 1 except that the quantity of hydrophobic silica particles with an average particle size of 160 nm was changed from 2.4 parts to 3.1 parts, and the quantity of colloidal silica with an average particle size of 20 nm (Aeroxil R972, available from Nippon Aerosil Co., Ltd.) was changed from 1.4 parts to 2.1 parts for the external addition treatment.

The evaluation was conducted in the same manner as Example 1, except for the use of Toner 3.

### Example 4

Toner 4 was obtained in the same manner as in Example 1 except that the stirring time of Henschel Mixer was changed from 8 to 4 minutes for the external additive treatment.

The evaluation was conducted in the same manner as Example 1, except for the use of Toner 4.

### Example 5

Toner 5 was obtained in the same manner as in Example 1 except that the stirring time of Henschel Mixer was changed from 8 to 12 minutes for the external additive treatment.

The evaluation was conducted in the same manner as Example 1, except for the use of Toner 5.

### Example 6

Toner 6 was obtained in the same manner as in Example 1 except that the quantity of hydrophobic silica particles with an average particle size of 160 nm was changed from 2.4 parts to 1.3 parts, and the quantity of colloidal silica with an average particle size of 20 nm (Aeroxil R972, available from Nippon Aerosil Co., Ltd.) was changed from 1.4 parts to 1.2 parts, and the stirring time of Henschel Mixer was changed from 8 to 4 minutes for the external additive treatment.

The evaluation was conducted in the same manner as Example 1, except for the use of Toner 6.

### Example 7

Toner 7 was obtained in the same manner as in Example 1 except that the quantity of hydrophobic silica particles with an average particle size of 160 nm was changed from 2.4 parts to 1.7 parts, and the quantity of colloidal silica with an average particle size of 20 nm (Aeroxil R972, available from Nippon Aerosil Co., Ltd.) was changed from 1.4 parts to 0.8 parts, and the stirring time of Henschel Mixer was changed from 8 to 12 minutes for the external additive treatment.

The evaluation was conducted in the same manner as Example 1, except for the use of Toner 7.

### Example 8

Toner 8 was obtained in the same manner as in Example 1 except that the quantity of hydrophobic silica particles with an average particle size of 160 nm was changed from 2.4 parts to 3.1 parts, and the quantity of colloidal silica with an average particle size of 20 nm (Aeroxil R972, available from Nippon Aerosil Co., Ltd.) was changed from 1.4 parts to 2.1 parts, and the stirring time of Henschel Mixer was changed from 8 to 4 minutes for the external additive treatment.

The evaluation was conducted in the same manner as Example 1, except for the use of Toner 8.

### Example 9

Toner 9 was obtained in the same manner as in Example 1 except that the quantity of hydrophobic silica particles with an average particle size of 160 nm was changed from 2.4 parts to 3.3 parts, and the quantity of colloidal silica with an average particle size of 20 nm (Aeroxil R972, available from Nippon Aerosil Co., Ltd.) was changed from 1.4 parts to 1.9 parts, and the stirring time of Henschel Mixer was changed from 8 to 12 minutes for the external additive treatment.

The evaluation was conducted in the same manner as Example 1, except for the use of Toner 9.

### Example 10

In Example 1, the mixture of 33 parts of aqueous liquid dispersion (W-1) and 60 parts of aqueous dispersion (W0-1) used for preparing Aqueous Phase 1 was changed to a mixture of 48 parts of aqueous liquid dispersion (W-1) and 45 parts of aqueous liquid dispersion (W0-1), resulting in formation of Aqueous Phase 2. Mother Toner Particle 2 was obtained following the same procedure as in Example 1, except for the use of Aqueous Phase 2. Toner 10 was obtained following the same manner as in Example 1, using Mother Toner Particle 2.

The evaluation was conducted in the same manner as Example 1, except for the use of Toner 10.

### Example 11

In Example 1, the mixture of 33 parts of aqueous liquid dispersion (W-1) and 60 parts of aqueous dispersion W0-1 used for preparing Aqueous Phase 1 was changed to a mixture of 60 parts of aqueous liquid dispersion (W-1) and 33 parts of aqueous liquid dispersion (W0-1), resulting in formation of Aqueous Phase 4. Mother Toner Particle 4 was obtained following the same procedure as in Example 1, except for the use of Aqueous Phase 4. Toner 11 was obtained following the same manner as in Example 1, using Mother Toner Particle 4.

The evaluation was conducted in the same manner as Example 1, except for the use of Toner 11.

### Example 12

In Example 1, the mixture of 33 parts of aqueous liquid dispersion (W-1) and 60 parts of aqueous liquid dispersion (W0-1) used for preparing Aqueous Phase 1 was changed to a mixture of 53 parts of aqueous liquid dispersion (W-1) and 40 parts of aqueous liquid dispersion (W0-1), resulting in formation of Aqueous Phase 3. Mother Toner Particle 3 was obtained following the same procedure as in Example 1, except for the use of Aqueous Phase 3. Toner 12 was obtained following the same manner as in Example 1, using Mother Toner Particle 3. The evaluation was conducted in the same manner as Example 1, except for the use of Toner 12.

### Example 13

In Example 1, the mixture of 33 parts of aqueous liquid dispersion (W-1) and 60 parts of aqueous liquid dispersion (W0-1) used for preparing Aqueous Phase 1 was changed to a mixture of 70 parts of aqueous liquid dispersion (W-1) and 23 parts of aqueous liquid dispersion (W0-1), resulting in formation of Aqueous Phase 5. Mother Toner Particle 5 was obtained following the same procedure as in Example 1, except for the use of Aqueous Phase 5. Toner 13 was obtained following the same manner as in Example 1, using Mother Toner Particle 5.

The evaluation was conducted in the same manner as Example 1, except for the use of Toner 13.

### Example 14

In Example 1, the mixture of 33 parts of aqueous liquid dispersion W-1 and 60 parts of aqueous dispersion W0-1 used for preparing Aqueous Phase 1 was changed to 83 parts of the resin fine particle liquid dispersion 1, resulting in formation of Aqueous Phase 6. Mother Toner Particle 6 was obtained following the same procedure as in Example 1, except for the use of Aqueous Phase 6. Toner 14 was obtained following the same manner as in Example 1, using Mother Toner Particle 6.

The evaluation was conducted in the same manner as Example 1, except for the use of Toner 14.

### Example 15

In Example 1, Inorganic Filler 1 (trimethyl stearyl ammonium modified montmorillonite) used for preparing Oil Phase 1 was changed from 8 parts to 10 parts to obtain Oil Phase 2. Mother Toner Particle 7 was obtained following the same procedure as in Example 1, except for the use of Aqueous Phase 2. Toner 15 was obtained following the same manner as in Example 1, using Mother Toner Particle 7.

The evaluation was conducted in the same manner as Example 1, except for the use of Toner 15.

### Example 16

In Example 1, Inorganic Filler 1 (trimethyl stearyl ammonium modified montmorillonite) used for preparing Oil Phase 1 was changed from 8 parts to 6 parts to obtain Oil Phase 4. Mother Toner Particle 9 was obtained following the same procedure as in Example 1, except for the use of Aqueous Phase 4. Toner 16 was obtained following the same manner as in Example 1, using Mother Toner Particle 9.

The evaluation was conducted in the same manner as Example 1, except for the use of Toner 16.

### Example 17

In Example 1, Inorganic Filler 1 (trimethyl stearyl ammonium modified montmorillonite) used for preparing Oil Phase 1 was changed from 8 parts to 12 parts to obtain Oil Phase 3. Mother Toner Particle 8 was obtained following the same procedure as in Example 1, except for the use of Aqueous Phase 3. Toner 17 was obtained following the same manner as in Example 1, using Mother Toner Particle 8.

The evaluation was conducted in the same manner as Example 1, except for the use of Toner 17.

### Example 18

In Example 1, Inorganic Filler 1 (trimethyl stearyl ammonium modified montmorillonite) used for preparing Oil Phase 1 was changed from 8 parts to 4 parts to obtain Oil Phase 5. Mother Toner Particle 10 was obtained following the same procedure as in Example 1, except for the use of Aqueous Phase 5. Toner 18 was obtained following the same manner as in Example 1, using Mother Toner Particle 10.

The evaluation was conducted in the same manner as Example 1, except for the use of Toner 18.

### Comparative Example 1

Toner 19 was obtained in the same manner as in Example 1 except that the quantity of hydrophobic silica particles with an average particle size of 160 nm was changed from 2.4 parts to 3.2 parts, and the quantity of colloidal silica with an average particle size of 20 nm (Aeroxil R972, available from Nippon Aerosil Co., Ltd.) was changed from 1.4 parts to 2.2 parts for the external addition treatment.

The evaluation was conducted in the same manner as Example 1, except for the use of Toner 19.

### Comparative Example 2

Toner 20 was obtained in the same manner as in Example 1 except that the quantity of hydrophobic silica particles with an average particle size of 160 nm was changed from 2.4 parts to 1.6 parts, and the quantity of colloidal silica with an average particle size of 20 nm (Aeroxil R972, available from Nippon Aerosil Co., Ltd.) was changed from 1.4 parts to 0.8 parts for the external addition treatment.

The evaluation was conducted in the same manner as Example 1, except for the use of Toner 20.

### Comparative Example 3

Toner 21 was obtained in the same manner as in Example 1 except that the quantity of hydrophobic silica particles with an average particle size of 160 nm was changed from 2.4 parts to 1.7 parts, and the quantity of colloidal silica with an average particle size of 20 nm (Aeroxil R972, available from Nippon Aerosil Co., Ltd.) was changed from 1.4 parts to 0.8 parts, and the stirring time of Henschel Mixer was changed from 8 to 14 minutes for the external additive treatment.

The evaluation was conducted in the same manner as Example 1, except for the use of Toner 21.

### Comparative Example 4

Toner 22 was obtained in the same manner as in Example 1 except that the quantity of hydrophobic silica particles with an average particle size of 160 nm was changed from 2.4 parts to 3.1 parts, and the quantity of colloidal silica with an average particle size of 20 nm (Aeroxil R972, available from Nippon Aerosil Co., Ltd.) was changed from 1.4 parts to 2.1 parts, and the stirring time of Henschel Mixer was changed from 8 to 3 minutes for the external additive treatment.

The evaluation was conducted in the same manner as Example 1, except for the use of Toner 22.

### Comparative Example 5

Toner 23 was obtained in the same manner as in Example 1 except that Mother Toner Particle 1 was substituted with Mother Toner Particle 4, following the same external additive treatment as Example 1.

The evaluation was conducted in the same manner as Example 1, except for the use of Toner 23.

### Comparative Example 6

Toner 24 was obtained in the same manner as in Example 1 except that Mother Toner Particle 1 was substituted with Mother Toner Particle 2, following the same external addition treatment as Example 1.

The evaluation was conducted in the same manner as Example 1, except for the use of Toner 24.

### Manufacturing of Carrier

A total of 100 parts of silicone resin (organo straight silicone), 5 parts of γ-(2-aminoethyl)aminopropyl trimethoxy silane, and 10 parts of carbon black were added to 100 parts of toluene followed by dispersion for 20 minutes by a HOMOMIXER to prepare a resin layer liquid application.

Using a fluid bed type coating device, the resin layer liquid application was applied to the surface of spherical magnetite with a volume average particle diameter of 50 μm, totaling 1,000 parts by mass, to produce Carrier.

### Manufacturing of Developing Agent

Five parts of each Toner was mixed with 95 parts of Carrier using a ball mill to manufacture Developing Agent.

Toner 1 to Toner 24 were evaluated on the following evaluation items according to the respective evaluation methods.

### Average Circularity

Using a wet flow-type particle image analyzer, specifically the FPIA-2100 with analysis software (FPIA-2100 Data Processing Program for FPIA version 00-10, available from Sysmex Corporation), the average circularity of the toner was measured. In a 100 mL glass beaker, a 10 percent aqueous solution of alkylbenzene sulfonate NeoGen SC-A (obtained from DKS Co., Ltd.) ranging from 0.1 to 0.5 mL and toner ranging from 0.1 to 0.5 g were added. Stirring was performed using a micro spatula, followed by the addition of 80 mL of deionized water. Subsequently, the mixture underwent ultrasonic dispersion using an ultrasonic homogenizer UH-50 (available from SMT Co., Ltd.) for 1 minute under conditions of 20 kHz and 50 W/10 cm³. This ultrasonic dispersion was followed by a total dispersion time of 5 minutes to obtain the measuring sample. A segment of this measuring sample, characterized by particle concentrations ranging from 4,000 to 8,000 particles/10⁻³ cm³, was utilized for determining the average circularity of particles with an equivalent circular diameter between 0.60 μm and just under 159.21 μm.

The coverage ratio of resin fine particles on the surface of mother toner particles was determined as follows:

Resin fine particles on the surface of a mother toner particle were observed using a scanning electron microscope (SEM), and the captured image was processed using image analysis software to calculate the area ratio of the resin fine particle to the mother toner particle. The method of observing resin fine particles that was executed is described as follows: Observation of resin fine particles involves the liberation of external additives through ultrasonic treatment to remove them maximally, allowing for the observation of resin fine particles in a state close to that of the original mother toner particle.

### Determination of Coverage Ratio of Resin Fine Particle

(1): Pour 50 mL of a 5 percent by mass aqueous solution containing a surfactant (Noigen ET-165, available from DKS Co., Ltd.) into a 100 mL screw tube. Then add 3 grams of toner to the liquid mixture and gently shake it in various directions. Subsequently, stir the liquid dispersion on a ball mill stand for 30 minutes to ensure thorough integration of the toner into the liquid dispersion.
(2): Using an ultrasonic homogenizer (model: VCX750, CV33, available from Sonics & Materials Inc.), set the output to 40 W and apply ultrasonic energy continuously for 60 minutes.

### Ultrasonic Conditions

Duration: 60 minutes continuously
Amplitude: 40 W
Temperature at initial vibration: 23±1.5 degrees C.
Temperature during vibration: 23±1.5 degrees C.
(3): Perform suction filtration on the liquid dispersion using No. 2 qualitative filter paper (110 mm, available from Advantec Toyo Kaisha, Ltd.). Follow this by rinsing twice with deionized water to remove any released (liberated) additives, and subsequently dry the obtained toner particles.
(4): Image the toner obtained in the (3) using a scanning electron microscope (SEM). Initially, detect external additives or inorganic fillers containing Si by observing the reflected electron image.
(5): Convert the image from the (4) into binary form using an image processing software (ImageJ) to eliminate the previously detected remaining external additives and inorganic fillers.
(6): Next, observe the secondary electron image at the same positions as in the (3). Resin fine particles are only visible in the secondary electron image, not in the reflected electron image. Compare this with the image obtained in the (5) and observe the resin fine particles present in the portion where the remaining inorganic additives and fillers were excluded as the resin fine particles.

### Imaging Condition

Scanning Electron Microscope: SU-8230 (available from Hitachi High-Technologies Corporation)
Magnification: 35,000×
Imaging Modes: SE (L) (Secondary Electrons), Backscattered Electrons (BSE)
Accelerating Voltage: 2.0 kV
Beam Current: 1.0 μA
Probe Current: Normal
Focus Mode: UHR
Working Distance (WD): 8.0 mm
(7): From the (6), generate an image displaying only resin fine particles within the mother toner particle after removing inorganic additives and fillers. Calculate the area occupied by the resin fine particles using image processing software in relation to the mother toner particle. Capture an image at 35,000× magnification to ensure the entire image is filled with the mother toner particle, then calculate the area occupied by the resin fine particles within this image. Subsequently, consider the image area as the area of mother toner particles and calculate the proportion of the area occupied by the resin fine particles within the image area as the coverage ratio of the resin fine particles. Repeat this process with images of ten different mother toner particles and use the average values as the coverage ratio of the resin fine particles.

The silica content ratio C was assessed using a fluorescent X-ray device (ZSX-100e, available from Rigaku Corporation) for quantitative analysis to quantify the number of parts of silica in the sample toner formed into pellets. The calibration curve used was prepared using sample toners containing 0.1 parts, 1 part, and 1.8 parts of silica content per 100 parts of toner, in advance.

Silica liberation ratios A and B (percent by mass) were calculated based on the relationship below.

Liberation ratio of silica (percent by mass)=([Content (number of parts) of silica in the sample toner prior to processing]−[Final content (number of parts) of silica in the processed sample toner])/[Number of sample toner prior to processing]×100

The liberation ratio A of silica represents the ratio at an ultrasonic condition amplitude of 20 W during the liberation method of the silica, while the liberation ratio B indicates the ratio at an ultrasonic condition amplitude of 60 W during the liberation method of the silica.

Using Toner 1 to Toner 24 and the developing agents, low temperature fixability, heat-resistant storage stability, and resistance of additive to filming, and charging stability were evaluated in the following manner.

### Low Temperature Fixability

Each toner was uniformly deposited on the paper surface to achieve a density of 0.8 mg/cm². The method employed for depositing the powder onto the paper involved using a printer without the heat-fixing unit. If the powder could be uniformly deposited at the above-mentioned weight density, other methods were permissible. The minimum film-forming temperature (MFT) of cold offset was measured when this paper, with the toner applied, passed through the pressure fixing roller at a fixing speed (circumferential speed of the heating roller) of 213 mm/see and a fixing pressure (pressure of the pressure roller) of 10 kg/cm². A lower MFT of cold offset is associated with better low-temperature fixability.

### Evaluation Criteria of Cold Offset

S: The lowest fixing temperature was lower than 130 degrees C.
A: The lowest fixing temperature was higher than 130 degrees C. to 135 degrees C.
B: The lowest fixing temperature was higher than 135 degrees C. to 140 degrees C.
C: The lowest fixing temperature was high than 140 degrees C.

### Heat-Resistant Storage Stability

Ten grams of the toner were filled into a 50 mL glass container, and the container was adequately tapped until there was no further change in the apparent density of the obtained powdered toner. The container was then sealed with a lid. After allowing the container to rest in a constant-temperature bath at 50 degrees C. for 24 hours, it was cooled to 24 degrees C. Subsequently, the needle penetration test (JIS K2235-1991, petroleum waxes) was conducted to measure the needle penetration, and the heat-resistant storage stability was evaluated based on the following criteria.

A higher needle penetration value indicates superior heat-resistant storage stability. Products with a needle penetration of less than 15 mm is likely to encounter issues during use.

### Evaluation Criteria

S: Penetration degree was 25 or more mm
A: Penetration degree was 20 mm to less than 25 mm
B: Penetration degree was 15 mm to less than 20 mm
C: Penetration degree was less than 15 mm

### Resistance of Additive to Filming

Using an image forming apparatus (imageo MP C5002, available from Ricoh Co., Ltd.), a vertical stripe chart with an image area ratio of 30 percent was output in the laboratory environment at 27 degrees C. and 90 percent relative humidity with a run length of 5,000 sheets (A4 size in landscape orientation) over three print/job. Subsequently, 5,000 blank sheets (A4 size in landscape orientation) were output over three print/job. Following this print sequence, the photoconductor was visually inspected after printing a single halftone image, and the resistance of additives to filming was evaluated based on predefined criteria.

### Evaluation Criteria

S: No issues with the photoconductor. No quality problems.
A: Slight filming along the printing direction, but at a level where there are no quality issues in the image, so no problem.
C: Clear occurrence of filming on the photoconductor, resulting in image quality problems at a significant level.

### Charging Stability

Using each developer, a durability test was conducted by outputting 100,000 continuous sheets with a character image pattern at a 12 percent image area ratio. The change in charge potential was evaluated during this process. A small amount of the developer on the developing sleeve was collected, and the change in charge potential was determined using the blow-off method. Evaluation was based on the following criteria: B or higher rated image indicates a level suitable for practical use.

### Evaluation Criteria

S: Change in charge potential is less than 3 μC/g
A: Change in charge potential is from 3 to less than 6 μC/g
B: Change in charge potential is from 6 to less than 10 μC/g
C: Change in charge potential is 10 or more μC/g

The evaluation results for Toner 1 to Toner 24 are shown in Tables 2 to 4.

TABLE 2

| | | Exam- | Exam- | Exam- | Exam- | Exam- |
|---|---|---|---|---|---|---|
| | | ple 1 | ple 2 | ple 3 | ple 4 | ple 5 |
| | | Toner 1 | Toner 2 | Toner 3 | Toner 4 | Toner 5 |
| Circularity | | 0.980 | 0.980 | 0.980 | 0.980 | 0.980 |
| Coverage | | 50 | 50 | 50 | 50 | 50 |
| ratio of | | | | | | |
| resin fine | | | | | | |
| particle | | | | | | |
| Liberation | A (%) | 30 | 30 | 30 | 30 | 30 |
| ratio of | B (%) | 35 | 35 | 35 | 40 | 30 |
| silica | B − A | 5 | 5 | 5 | 10 | 0 |
| Content | C (%) | 3.65 | 2.4 | 4.9 | 3.65 | 3.65 |
| ratio of | | | | | | |
| silica | | | | | | |
| Evaluation | Low | S | S | A | S | S |
| results | temperature | | | | | |
| | fixability | | | | | |
| | Heat- | S | A | S | S | S |
| | resistant | | | | | |
| | storage | | | | | |
| | stability | | | | | |
| | Filming | S | S | S | S | S |
| | property of | | | | | |
| | additive | | | | | |
| | Charge | S | S | S | S | S |
| | stability | | | | | |

| | | Exam- | Exam- | Exam- | Exam- |
|---|---|---|---|---|---|
| | | ple 6 | ple 7 | ple 8 | ple 9 |
| | | Toner 6 | Toner 7 | Toner 8 | Toner 9 |
| Circularity | | 0.980 | 0.980 | 0.980 | 0.980 |
| Coverage ratio of | | 50 | 50 | 50 | 50 |
| resin fine particle | | | | | |
| Liberation ratio of | A (%) | 21 | 21 | 40 | 40 |
| silica | B (%) | 31 | 21 | 50 | 40 |
| | B − A | 10 | 0 | 10 | 0 |
| Content ratio of | C (%) | 2.4 | 2.4 | 4.9 | 4.9 |
| silica | | | | | |
| Evaluation results | Low | S | S | A | A |
| | temperature | | | | |
| | fixability | | | | |
| | Heat- | A | A | S | S |
| | resistant | | | | |
| | storage | | | | |
| | stability | | | | |
| | Filming | S | S | S | S |
| | property of | | | | |
| | additive | | | | |
| | Charge | S | S | S | S |
| | stability | | | | |

TABLE 3

| | | Exam- | Exam- | Exam- | Exam- | Exam- |
|---|---|---|---|---|---|---|
| | | ple 10 | ple 11 | ple 12 | ple 13 | ple 14 |
| | | Toner | Toner | Toner | Toner | Toner |
| | | 10 | 11 | 12 | 13 | 14 |
| Circularity | | 0.980 | 0.980 | 0.980 | 0.980 | 0.980 |
| Coverage | | 30 | 70 | 29 | 71 | None |
| ratio of | | | | | | |
| resin fine | | | | | | |
| particle | | | | | | |
| Liberation | A (%) | 28 | 32 | 26 | 37 | 21 |
| ratio of | B (%) | 32 | 39 | 29 | 45 | 27 |
| silica | B − A | 4 | 7 | 3 | 8 | 6 |
| Content | C (%) | 3.65 | 3.65 | 3.65 | 3.65 | 3.65 |
| ratio of | | | | | | |
| silica | | | | | | |
| Evaluation | Low | S | S | S | S | S |
| results | temperature | | | | | |
| | fixability | | | | | |
| | High | S | S | A | S | B |
| | temperature | | | | | |
| | storage | | | | | |
| | Filming | S | S | S | A | S |
| | property of | | | | | |
| | additive | | | | | |
| | Charge | S | S | A | A | A |
| | stability | | | | | |

| | | Exam- | Exam- | Exam- | Exam- |
|---|---|---|---|---|---|
| | | ple 15 | ple 16 | ple 17 | ple 18 |
| | | Toner | Toner | Toner | Toner |
| | | 15 | 16 | 17 | 18 |
| Circularity | | 0.970 | 0.987 | 0.969 | 0.988 |
| Coverage ratio of | | 50 | 50 | 50 | 50 |
| resin fine particle | | | | | |
| Liberation ratio of | A (%) | 24 | 38 | 24 | 38 |
| silica | B (%) | 29 | 43 | 29 | 43 |
| | B − A | 5 | 5 | 5 | 5 |
| Content ratio of | C (%) | 3.65 | 3.65 | 3.65 | 3.65 |
| silica | | | | | |
| Evaluation results | Low | S | S | A | B |
| | temperature | | | | |
| | fixability | | | | |
| | High | S | S | B | A |
| | temperature | | | | |
| | storage | | | | |
| | Filming | S | S | A | B |
| | property of | | | | |
| | additive | | | | |
| | Charge | S | S | B | A |
| | stability | | | | |

TABLE 4

| | | Comparative | Comparative | Comparative |
|---|---|---|---|---|
| | | Example 1 | Example 2 | Example 3 |
| | | Toner 19 | Toner 20 | Toner 21 |
| Circularity | | 0.980 | 0.980 | 0.980 |
| Coverage ratio | | 50 | 50 | 50 |
| of resin fine | | | | |
| particle | | | | |
| Liberation ratio | A (%) | 40 | 21 | 19 |
| of silica | B (%) | 50 | 21 | 24 |
| | B − A | 10 | 0 | 5 |
| Content ratio | C (%) | 5 | 2.3 | 2.4 |
| of silica | | | | |
| Evaluation | Low | C | A | C |
| results | temperature | | | |
| | fixability | | | |
| | High | S | C | B |
| | temperature | | | |
| | storage | | | |
| | Filming | C | A | A |
| | property of | | | |
| | additive | | | |
| | Charge | B | A | A |
| | stability | | | |
| | | Comparative | Comparative | Comparative |
| | | Example 4 | Example 5 | Example 6 |
| | | Toner 22 | Toner 23 | Toner 24 |
| Circularity | | 0.980 | 0.980 | 0.980 |
| Coverage ratio | | 50 | 50 | 50 |
| of resin fine | | | | |
| particle | | | | |
| Liberation ratio | A (%) | 41 | 33 | 31 |
| of silica | B (%) | 46 | 44 | 30 |
| | B − A | 5 | 11 | −1 |
| Content ratio | C (%) | 4.9 | 3.65 | 3.65 |
| of silica | | | | |
| Evaluation | Low | B | A | A |
| results | temperature | | | |
| | fixability | | | |
| | High | S | A | B |
| | temperature | | | |
| | storage | | | |
| | Filming | C | C | C |
| | property of | | | |
| | additive | | | |
| | Charge | C | C | C |
| | stability | | | |

The results shown in Tables 2 to 4 highlight that Examples 1 through 11, 15, and 16 exhibit exceptional performance in terms of the low-temperature fixability, heat-resistant storage stability, and resistance of additives to filming, and charge stability. Through good control of resin fine particle coverage and circularity on the surface of the toner particles, the liberation ratio of inorganic external additives was adequately managed. This control strategy achieved a favorable equilibrium between the low-temperature fixability and heat-resistant storage stability. Consequently, it enhanced the resistance of additives to filming while maintaining high charge stability.

Contrarily, Examples 12 to 14 demonstrated inferior performance compared with Examples 1 through 11, 15, and 16 concerning the storage stability, filming characteristics, and charge stability due to inadequate resin fine particle coverage.

Additionally, Examples 17 and 18 suffered from suboptimal arrangement of additives due to inadequate circularity, an indicator of toner shape, resulting in quality deterioration. These examples displayed overall inferiority compared with Examples 1 through 11, 15, and 16.

Comparative Example 1 faced issues with poor fixability and filming characteristics due to an excessive amount of inorganic external additives.

Comparative Example 2 lacked adequate heat-resistant storage stability owing to an insufficient amount of the inorganic external additives.

Comparative Example 3 faced embedding of the external additives into the mother toner particle due to excessively low liberation ratio of the inorganic external additives, resulting in the inability to ensure the heat-resistant storage stability.

Comparative Example 4 suffered from both deteriorated filming characteristics of additives and deteriorated charge stability due to an excessively high liberation ratio of the inorganic external additives.

Comparative Example 5 exhibited exacerbated filming characteristics and deteriorated charge stability due to excessive fluctuations in the liberation ratio of inorganic external additives.

Comparative Example 6 presented negative fluctuations in the liberation ratio of the inorganic external additives, resulting in insufficient embedding strength of the external additives into mother toner particles. Consequently, this insufficient embedding led to easy liberation of the external additives during printing by the machine, further degrading the filming characteristics and charge stability.

Aspects of the present disclosure are, for example, as follows.

Aspect 1: A toner contains a mother toner particle containing a resin, a colorant, and a wax, and an inorganic external additive on the surface of the mother toner particle, wherein the following relationships are satisfied.

$$20 < A \leq 40 \qquad Relationship 1$$

$$0 \leq B - A \leq 10 \qquad Relationship 2$$

$$2.3 < C < 5. , \qquad Relationship 3$$

where A (percent by mass) represents a liberation ratio of the inorganic external additive separated by shaking the toner with ultrasonic wave at a power of 20 W and a frequency of 20 kHz for one minute, B (percent by mass) represents a liberation ratio of the inorganic external additive separated by shaking the toner with ultrasonic wave at a power of 60 W and a frequency of 20 kHz for one minute, and C (percent by mass) represents a proportion of the inorganic external additive to the toner.

Aspect 2: The toner according to Aspect 1 mentioned above, wherein the toner has an average circularity of 0.970 to 0.987.

Aspect 3: The toner according to Aspect 1 or 2 mentioned above, further contains resin fine particles on the surface of the mother toner particle, wherein the coverage ratio of the surface of the mother toner particle with the resin fine particles is from 30 to 70 percent by mass.

Aspect 4: A developing agent contains a carrier and the toner of any one of Aspect 1 to Aspect 3 mentioned above.

Aspect 5: A toner accommodating unit includes the toner of any one of Aspect 1 to Aspect 3 mentioned above.

Aspect 6: An image forming apparatus comprising:
a latent electrostatic image bearer, a latent electrostatic image forming device to form a latent electrostatic image on the latent electrostatic image bearer, a developing device to develop the latent electrostatic image with the toner of any one of Aspect 1 to Aspect 3 mentioned above to form a visible image, a transfer device to transfer the visible image onto a recording medium to obtain a transfer image, and a fixing device to fix the transfer image transferred to the recording medium.

Aspect 7: An image forming method includes forming a latent electrostatic image on a latent electrostatic image bearer, developing the latent electrostatic image with the toner of any one of Aspect 1 to Aspect 3 mentioned above to obtain a visible image, transferring the visible image to a recording medium to obtain a transfer image, and fixing the transfer image on the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner comprising:
a mother toner particle comprising:
a resin;
a colorant; and
a wax; and
an inorganic external additive on a surface of the mother toner particle,
wherein the following relationships are satisfied:
$$20 < A \leq 40 \qquad Relationship 1$$
$$0 \leq B - A \leq 10 , \qquad Relationship 2$$
$$2.3 < C < 5. \qquad Relationship 3$$
where A (percent by mass) represents a liberation ratio of the inorganic external additive separated by shaking the toner with ultrasonic wave at a power of 20 W and a frequency of 20 kHz for one minute,
B (percent by mass) represents a liberation ratio of the inorganic external additive separated by shaking the toner with ultrasonic wave at a power of 60 W and a frequency of 20 kHz for one minute, and
C (percent by mass) represents a proportion of the inorganic external additive to the toner.

2. The toner according to claim 1, wherein the toner has an average circularity of 0.970 to 0.987.

3. The toner according to claim 1,
further comprising resin fine particles on the surface of the mother toner particle,
wherein a coverage ratio of the surface of the mother toner particle with the resin fine particles is from 30 to 70 percent by mass.

4. A developing agent comprising:
the toner of claim 1.

5. A toner accommodating unit accommodating the toner of claim 1.

6. An image forming apparatus comprising:
a latent electrostatic image bearer;
a latent electrostatic image forming device to form a latent electrostatic image on the latent electrostatic image bearer;
a developing device to develop the latent electrostatic image with the toner of claim 1 to form a visible image;
a transfer device to transfer the visible image onto a recording medium to obtain a transfer image; and
a fixing device to fix the transfer image transferred to the recording medium.

7. An image forming method comprising:
forming a latent electrostatic image on a latent electrostatic image bearer;
developing the latent electrostatic image with the toner of claim 1 to obtain a visible image;
transferring the visible image to a recording medium to obtain a transfer image; and
fixing the transfer image on the recording medium.
